SEQUENCE LISTING (22 sequences)

SEQ ID NO: 1 - DNA, 625 bp, V. inaequalis sf sp pomi EUB04
  misc_feature: Vina_EUB04 locus g9008
cacctcctgtcggctggattcaacctgtggtccgtttttctatctctatcttcacagtcctacctagggccaatcatggcgatgcagattctaatcctatgagagcaggcttccataacttcaacaggtggttatgtctggccgcgttatgtagcatggtattcttcgctcaaactacacaactatgccgtcagcggtgccgtttgctcaaataccatcactccgcgagcgtttctgccgcagatcaactttctattcccatccgtgctcgaatacgaggtgccagcttttctagcggacaaatcgtacaaaggtcccctcacgaatacaacgacacccatcgaactagatgacgataaaaccgtttatgccatctggatcggaacaaacgacttgggaaatgatgcctttctcacggatagtcaggtggaagggaaacagatcaccgactacatcgattgtgtttactcatctctcgacaagatttacgcagctggtgggagatggttcattctaatgaacgtgattccgttgaatctgcttcctcaatacgcacttcccagtaatggaggagcaaccgcgacgcgttccttcccgaacaaagcaagcttcaacgccacagaaa

SEQ ID NO: 2 - DNA, 363 bp, V. inaequalis sf sp pomi EUB04
  misc_feature: Vina_EUB04 locus g12572
atgaagcttctactcattactgctgtgctggggctcttttcccagtaagttttacttccaccatcatgattcccccccccccccccccccccccccccgagtggaactaaaagacccataggttagcctcaggatgtcaatgcaaagctatgaccccctcagcagtcagagtctacacacaaagggcgtgtactcgttgtcgcggaaattttgacgccgaaccatacgaggttggtacaaaggaaagcttttgtcacaacgcattcctaacaccaatagtgcggtggatcaaatcacgcctgcttcaattcagcatgcacggcatcgacaggaataactgtcaaaccttcaacctgtccatga

SEQ ID NO: 3 - DNA, 419 bp, V. inaequalis sf sp pomi EUB04
  misc_feature: Vina_EUB04 locus g13513
atgaagtctgtccaaaccttcgtcgcgttcttgcttgctaccaccgtctccgccgaatacgtatgttttacctccaagaactctcccgtttttacaataaggaagtctcctaactctccttccacagtacaaatgtaaaacaggccacactaccggtaccaaatcaggcaaatgttttgcctaccaagatggcaccaacaatatcattccttacaggactgagagactatgtcgtgatgtatgtgcaaccctcccacccaccccaccccacaaacatctttctagtctcctagcgttccatgacaatttgcggcacgggatggactgactgtaaatagctcgcaccttgtagagccgatgggacaaagtgtacctaccacggagaacaggttcaaggcacttggtactcaaactgttag

SEQ ID NO: 4 - DNA, 477 bp, V. inaequalis sf sp pyracanthae 1669
  misc_feature: Vina_1669 locus g9937
tcggaaactcaatgcgactgtcaatggtggaaaattgactgagaatgttttggagacgactatcctcgacagcgatctggatgcagatatcccatgggacacagatggccaaacgtacatcgcgagctattcgaagaccttgcctgatcccgactccttcgctgtagacaagcagtcaaccttccgagtgtccaactacactgcttacaagatgttcctgctctggacggaaatagtcccatcttcgatcgtgctctcgtcgccaacgaattctatcgagggaggccctgtccagaaatggtactggattctttcgcctcctcggcttttcgaagcacccagtatcaatgtctgggctccgccacataatattacccaaaaaatggaggttttgatgacgacgctgaaccaagtgctgcgtagaaaccctacttctcggcttttacgaagcgatgtttccataggtgaagcattcac

SEQ ID NO: 5 - DNA, 191 bp, V. inaequalis sf sp pyracanthae 1669
  misc_feature: Vina_1669 locus g9936
ggtcgcaggagttattgctgaggccaagcgagctgaaatcgagatcagagctccaaccgttggtggagatattgttacgagcacagtcaaggcccgagctccagtaagaggctttctttattcgatcgactggcggcctcactaacagtccatagggtatgcaaaagggatcgggttgtacgggatgttaa

SEQ ID NO: 6 - DNA, 1995 bp, V. inaequalis sf sp pyracanthae 1669
  misc_feature: Vina_1669 locus g7519
atggagtaccataatcttaatagtgcgctagacgaaatacgcctgattacaatactcccggcgacccaccctgatcagagggaggacctgatcagctgtaccttagatcattactcgcttcaggataggcctctccttgatccagcagatgcacgttgtactgaaatcctggactggacgacaccacatgcgtctcacgaagaaatcagtgtacgctctgcttcgaaaagcaatggcgagcccagatggcgattctgttggggagagttcgttgctctctcatacacgtgggggaatccccaagaaaaatcagaaatcatcctcaacggctccttgatcaaagtacaaaggaatctcgaagctgcgttgcgaaatctgcgcaaaaagagacctatgcaatcgcgttgtaaaatttggaccgacgctctttgtatcaatcaaggcgaccttgcagagcgaagttcggaggtccagcgaatgcgactcatttacaaattggcagcgaatgttgtcatttggctgggatcggaagaagaaagtagcgactccgctatgaatctcattcagagcctgtccgacgcttgtgcatcgggaaacgacaaatctacaggacaagatcttcgtcaaaatgctgagcattttggcaaaggagtctggctagctcttagcttgttgcttgatcgaccatattggcgtcgaatgtggattatacaagagctatcgatgggaggccaaaaggcaccgatcttgtgtggggacaaggttgtgttatgggaagaccttttcagagctgtatatacatttggcaacactatcatcgatgtcatgttcttgtacattgatcgtgagagaagggcggctggtctatcgagctatggtctcaatcgaaacaaaatcatccacattaacgatgagcaaaaccatcaaagcggcgccggccagtctcagttcatgtgtctcttggacctgggtcggaaatcagaggcaactgatcagagagacaaagtatacggcatcttgggattgatggatccgactgtctcgggacaattgattccagactacacgctgcaaaccgaagatgtatacacacaatttgcccagacttttataacggctagtaagtcgtctcctcctaacaaatggataggactcacagatctcgcagcaaacagcctagatatcctggaacagtgtacggggaacaacaatagcctgccatcatgggtcccagactggaccaacaagaatcattaccgcctcttcagcggacggaagtccaattaccacacgagtgggagcacgaagccgatttttgaaatcaacagaagtagcagcgtcctgacggctcgaggtgtgaaagtagatgatatctcaggtcttggacaatcccactttgaagccgacacaatctgtacggggtttcacatacttacacaaactggcggcagcaccaacgcgtacggcacaggagaagccctcaaagatgcattatggaggactctcacaggtgactgtacacccaatggccaacccgcaccagagcattactcgtgtcttctcgattgtcccctacgagatgagtatccccatgcaacaccatggcgcggcgctcgtacattccttcgtttcttgacacagagtggatccctgttaatcgcaggcaagaggttggacagctatttcatcagtgacaccggtatttttcccgaacaggcgacagatgcgcttgagcggctatggagattttcaaggactcgtcgtttgatggttacgacacgggggagactcggaatggcgcctcatgaagcacgaaaggacgatcaagtttgggtacttcttggctgtgattttcccgttctgatgagacctgtgactgggactaatctcgtgaggactatagggccgtgttatgtccatggtataatgaaaggcgagacaatggggtggattgatagaggtaaactcgtagttcaggatgtgtccatcatctga

SEQ ID NO: 7 - DNA, 222 bp, V. inaequalis sf sp pyracanthae 1669
  misc_feature: Vina_1669 locus g3689
atgtcgccagcgttaagcagcagtctgtcgccgacagcgttcaagaccgtcagccgcacgactacagacttcctcgctatcctacaggctctcgcacacaacaatatcgccagcgttaagcagcagtctgtcgccgacagcgttgaggagcagcagcagcagcagtctccgcagtctgggaattgtccggagatcgatgtatcattccaccatattgacgcg

SEQ ID NO: 8 - DNA, 1239 bp, V. inaequalis sf sp pyracanthae 1669
  misc_feature: Vina_1669 locus g3422
atgatgaacaaacaacagcgggccgattctggagactcatcatcctcgcctcctccgccgcctccgccgcctccgccgccgcccttcgtcccacccttagttctaccgtcatctctaccaccactaccacctcggtcaggaccacgaccacgaccagaaccacaacctctccctcctcccccaccctttcccattcctgcgtctccatcccatcactatgctggattcacacgtacgccgagactggcatcgactgccaattccaacaattccgaccctcagccttcccggcaatttacatcacacaacgacaccgtcatgtcagaaactactatactcttgatacaggacatgttggagcttcgcgagaccagtgtcggtaaaagaagtcatctcaagaacaaccaaagagaattgagatccaaatcgcagcatctagcatcagctcaggaagattttatgaagacttgtgcattgctcgtggaagctcatgaaatagatcctcgtggatcaggcctcttggagaaaaagtggacgtacttgaaggcgcttacaagcgatgcgagatctcgagaaaaacaggctagcaaggcgcatgatgatctgtcaaagctggaagaccggctactgaagaaggaagaagaggtttacagcatcgttagtggaattcgacgaggagcgttcacgtcctcattgtatacgccaacagacgaccaactcactctgtcagattcaagttactccactgcctccactgcctccgttatcaacgacgcggacgcatattacgatcaaatcggctatatgaggctgctaagagagaagatcttcaatctcgataatgagcatcatcaggggatgaaaattcgagtcatcgaacgtagagtcggccagggttttgattcaaccgatcgtgatgtcgtacagaagtatttccagcagagaaagattttcttcgatggatacacagttgctaaggacacgatggaagagttgaggaggttgtgtgagcaacgaggagagtttcttgagccccctgatcttccaccggatccaacatattctcctcaagccgccgagccactctcaacgcatagtgactatcggaaccacctgaacaggaaattttacacgtcccagtggctgagaggactgcaaaatcgtcggattgtaacggctgcgcaagactctcgagatgcagagatatcttcaattgacgttgcgagctctgacctcgag

SEQ ID NO: 9 - DNA, 20 bp, artificial
  Forward Primer spPomi-F
gttatgtctggccgcgttat

SEQ ID NO: 10 - DNA, 20 bp, artificial
  Reverse Primer spPomi-R
agaaaagctggcacctcgta

SEQ ID NO: 11 - DNA, 19 bp, artificial
  Forward Primer spPyr-F
caagcgagctgaaatcgag

SEQ ID NO: 12 - DNA, 20 bp, artificial
  Reverse Primer spPyr-R
gtacaacccgatcccttttg

SEQ ID NO: 13 - DNA, 20 bp, artificial
  Forward Primer mat-a-F
cacctctttccagcagaagg

SEQ ID NO: 14 - DNA, 20 bp, artificial
  Reverse Primer mat-a-R
cgattcgcaggaacttgtca

SEQ ID NO: 15 - DNA, 20 bp, artificial
  Forward Primer mat-HMG-F
cccctctgactctgaacagc

SEQ ID NO: 16 - DNA, 20 bp, artificial
  Reverse Primer mat-HMG-R
tgtcgaaatcgtcaatctgc

SEQ ID NO: 17 - DNA, 20 bp, artificial
  Forward Primer qPCR spPomi-F
aaaggtcccctcacgaatac

SEQ ID NO: 18 - DNA, 20 bp, artificial
  Reverse Primer qPCR spPomi-R
gatctgtttcccttccacct

SEQ ID NO: 19 - DNA, 20 bp, artificial
  Forward Primer qPCR spPyr-F
gagttattgctgaggccaag

SEQ ID NO: 20 - DNA, 20 bp, artificial
  Reverse Primer qPCR spPyr-R
gccttgactgtgctcgtaac

SEQ ID NO: 21 - DNA, 20 bp, artificial
  POMI-specific probe
tgccatctggatcggaacaa

SEQ ID NO: 22 - DNA, 20 bp, artificial
  PYR-specific probe
gctccaaccgttggtggaga

(19) United States
(12) Patent Application Publication
(10) Pub. No.: US 2023/0217931 A1
(43) Pub. Date: Jul. 13, 2023

(54) BIO-CONTROL METHOD FOR COMBATING THE PROPAGATION OF PHYTOPATHOGENIC FUNGI AND OOMYCETES

(71) Applicants: Institut national de recherche pour l’agriculture, l’alimentation et l’environnement, PARIS (FR); INSTITUT NATIONAL SUPERIEUR DES SCIENCES AGRONOMIQUES, AGROALIMENTAIRES, HORTICOLES ET DU PAYSAGE, RENNES (FR); UNIVERSITE D'ANGERS, ANGERS (FR)

(72) Inventors: Bruno LE CAM, LA MEIGNANNE (FR); Valerie CAFFIER, ERDRE-EN-ANJOU (FR)

(21) Appl. No.: 17/784,013

(22) PCT Filed: Dec. 21, 2020
(86) PCT No.: PCT/FR2020/052580

§ 371 Date: Jun. 9, 2022

(30) Foreign Application Priority Data
Dec. 20, 2019 (FR) 1915276

(51) Int. Cl. A01N 63/30; A01N 63/00; A01P 1/00; A01P 3/00

(52) U.S. Cl. CPC A01N 63/30; A01N 63/00; A01P 1/00; A01P 3/00

(57) ABSTRACT

The present invention relates to a bio-control method for combating the propagation of phytopathogenic fungi or oomycetes on plants, comprising the application, to the soil and/or to the vegetative apparatus of plants that are infected or are capable of being infected by pathogenic endemic fungal or oomycete strains referred to as type A, of a composition comprising a mixture of at least two strains, referred to as type B, of the same species, said type B strains being non-pathogenic for said plant, sexually compatible with said pathogenic type A strains and characterized in that they exhibit: a) sexual reproduction, b) a sexual phase initiated in non-parasitic mode, c) reproduction according to a heterothallic mode, and d) the existence of special forms or divergent populations within the species, capable of producing, by crossing with the type A strains, descendants that are non-pathogenic or even sterile on said plant of interest, and characterized in that the mixture of non-pathogenic type B strains comprises strains of opposite mating-type signs.

### TECHNICAL FIELD

The present invention relates to a biocontrol method for combating the spread of phytopathogenic fungi or oomycetes on plants.

### STATE OF THE ART

Phytopathogenic fungi are the main cause of plant diseases and are responsible for about 70% of crop diseases. The economic losses due to fungal diseases in global agriculture and the annual cost of fungicide treatments are therefore very significant.

The use of fungicides or other alternatives by farmers to combat the proliferation of phytopathogenic fungi and/or oomycetes on crops are known from the prior art.

In the case of apple scab, due to the fungus Venturia inaequalis, which represents the main disease on apple tree in the world, an average of 25 fungicide treatments are applied per year in France to combat this disease, in orchards managed in organic farming as well as in conventional farming, which represents a burden of about 30 million euros of fungicide purchases for French arboriculturists. The most effective alternative to pesticides is currently the use of resistant varieties coupled with cultural methods (prophylaxis, varietal mix) (Didelot et al., 2016). However, the availability of long-lasting resistant varieties (combining several resistance genes) is currently lacking on the market.

Multiple biocontrol strategies (antagonistic fungi, plant defense stimulators, biocides of natural origin, etc.) have been tested for several years to combat scab, but with no proven success in practice in orchards.

There is still a need to develop new methods to combat the spread of phytopathogenic fungi or oomycetes responsible for diseases on agricultural and arboricultural crops, which are sustainably effective, specific to the phytopathogenic fungus or oomycete to be eradicated, non-toxic for the applicator (farmer), the environment and the consumer (absence of residues) and reduce the number of tractor passages in orchards.

The Applicant has developed a new biocontrol method to meet these needs.

This method makes it possible to break the biological cycle of a phytopathogenic fungus or oomycete by crossbreeding pathogenic strains with non-pathogenic strains to produce non-pathogenic or even sterile offspring. The biocontrol strategy according to the invention thus targets the sexual phase of phytopathogenic fungi or oomycetes, by forcing them to produce non-pathogenic offspring.

The Applicant has indeed demonstrated, in the case of the phytopathogenic fungus Venturia inaequalis, the existence of two special forms, one that specifically infects apple tree (f. sp pomi=POMI), and another that specifically infects pyracantha (f. sp pyracanthae=PYR), described in Le Cam et al. 2002 ‘Evidence of two formae speciales in Venturia inaequalis, responsible for apple and Pyracantha scab’, Phytopathology 92:314-320. And she observed that crossbreeding these strains corresponding to two special forms produces non-pathogenic offspring on apple tree. Knowing that within the same species of phytopathogenic fungus or oomycete, several special forms or divergent populations can exist, the Applicant proposes to promote this type of crossbreeds between strains of two special forms—or divergent populations, by massively introducing strains of special form or divergent population not pathogenic for the plant, which will develop on the vegetative apparatus contaminated by resident or endemic strains of pathogenic special form, producing non-pathogenic or even sterile offspring, and consequently a collapse of the pathogenic population. This biocontrol method is applicable to any cultivated area, whether in fields or in gardens. In a particular embodiment, the offspring are non-pathogenic or even sterile. This biocontrol method allows farmers to reduce the use of fungicides to a minimum, or even to be completely free of them after several years of application. This biocontrol method is advantageous in particular in that:
this is a new biocontrol method for phytopathogenic fungi and oomycetes;
it is species-specific, as it specifically targets the phytopathogenic fungus or oomycete to be eradicated;
it is non-toxic to humans and the environment;
it relies on the use of endemic fungi or oomycetes; and
it is sustainable because it does not create—a priori— selection pressure on the populations.

The Applicant has also recently shown that the application of PYR strains according to the invention to the vegetative apparatus during the vegetative growth phase (e.g. spring, summer) of plants infected or likely to be infected by POMI strains, makes it possible to protect the plants against a POMI infection. This is referred to as ‘phytoprotection’, in addition to ‘biocontrol’, as described below in the description.

The invention illustrated by the phytopathogenic fungus V. inaequalis responsible for apple scab is not limited to this phytopathogenic fungus and can be applied to other phytopathogenic fungi or oomycetes that have sexual reproduction.

### PRESENTATION OF THE INVENTION

Therefore, the invention has as a first object a biocontrol method for combating the spread of phytopathogenic fungi or oomycetes on plants, comprising the application, to the soil and/or to the vegetative apparatus of plants infected or liable to be infected by strains of endemic pathogenic fungi or oomycetes known as type A, of a composition comprising a mixture of at least two strains, called type B, of the same species or of a divergent population within said species, said type B strains being non-pathogenic for said plant, sexually compatible with said pathogenic type A strains and characterized in that they have:
a) a sexual reproduction,
b) a sexual phase initiated in a non-parasitic mode,
c) a reproduction according to a heterothallic mode, and
d) the existence of special forms or divergent populations within the species, capable of producing, by crossbreeding with type A strains, non-pathogenic or even sterile offspring on said plant of interest,

and characterized in that the mixture of non-pathogenic type B strains comprises strains of opposite sexual signs.

According to a particular embodiment, the type B strains are applied to the vegetative apparatus in the vegetative growth phase (e.g. spring, summer) of plants infected or liable to be infected by strains of pathogenic endemic fungi or oomycetes known as type A, then to the vegetative apparatus in the senescence phase (e.g. autumn) of said plants, in particular to the senescent leaves or to the dead leaves which have fallen on the soil, of said plants infected or liable to be infected by strains of endemic pathogenic fungi or oomycetes known as type A.

The invention also relates to a biocontrol method, characterized in that the two Venturia inaequalis type B strains of the special pyracantha-specific form (f. sp pyracantha or PYR) and of opposite sexual signs, are selected according to an in vitro method comprising:
an extraction step for the DNA of Venturia inaequalis strains;
a PCR or qPCR amplification step of specific nucleic sequences of the genome of the PYR strains, in particular nucleic sequences comprising a nucleic sequence identical or having at least 90% identity with one of the sequences SEQ ID NO: 4 to SEQ ID NO: 8, preferably the sequence SEQ ID NO: 5, by means of specific nucleic primers, in particular a forward primer with a nucleic sequence which is identical or has at least 90% identity with the sequence SEQ ID NO:11 or SEQ ID NO:19 (forward primer sp Pyr-F) and a reverse primer with a nucleic sequence which is identical or has at least 90% identity with the sequence SEQ ID NO:12 or SEQ ID NO:20 (reverse primer sp Pyr-R);
an amplification step by PCR or qPCR of sequences specific to the mating-type locus, comprising the use of a pair of mat-alpha primers consisting of the sequences comprising a nucleic sequence identical or having at least 90% identity with the sequence SEQ ID NO: 13 (forward primer mat-alpha-F) and a nucleic sequence identical or having at least 90% identity with the sequence SEQ ID NO: 14 (reverse primer mat-alpha-R) and a pair of mat-HMG primers consisting of the sequences comprising a nucleic sequence identical or having at least 90% identity with the sequence SEQ ID NO: 15 (forward primer mat-HMG-F) and a nucleic sequence identical or having at least 90% identity with the sequence SEQ ID NO: 16 (reverse primer mat-HMG-R),
and optionally a detection step of said amplified sequences by means of probes, preferably labelled with fluorophores.

The invention also relates to a biocontrol composition comprising a mixture of at least two sexually opposite type B strains of a phytopathogenic fungus or oomycete not pathogenic to the plant to be treated and which are sexually compatible in crossbreeding with type A strains of the same species or related but pathogenic and endemic to the plant to be treated. In particular, said phytopathogenic fungus is selected from the group consisting of: Venturia inaequalis responsible for apple scab, Zymoseptoria tritici responsible for septoria in wheat, Blumeria graminis responsible for powdery mildew in wheat, Mycosphaerella fijiensis responsible for cercosporiose in banana, and Leptosphaeria maculans responsible for crown necrosis in oilseed rape; and said oomycete is selected from the group consisting of: Plasmopara viticola responsible for downy mildew of grapevine, and Phytophthora infestans responsible for downy mildew of potato and tomato, in particular for use in the biocontrol method according to the invention.

According to a particular and preferred embodiment, said composition comprises at least a mixture of the V. pyra 1669 strain deposited at the CNCM under the No. CNCM I-5456 and the V. pyra 2507 strain deposited at the CNCM under the No. CNCM I-5457, or a mixture of the V. pyra 1381 strain deposited at the CNCM under the No. CNCM I-5627 and the V. pyra 1387 strain deposited at the CNCM under the No. CNCM I-5629, or a mixture of the V. pyra 1381 strain and the V. pyra 2299 strain deposited at the CNCM under the No. CNCM I-5630, or a mixture of the V. pyra 1386 strain deposited at the CNCM under the No. CNCM I-5628 and the V. pyra 1387 strain deposited at the CNCM under the No. CNCM I-5629, or a mixture of the V. pyra 1386 strain and the V. pyra 2299 strain deposited at the CNCM under the No. CNCM I-5630.

Another object of the invention is a phytoprotection method for combating plant infection by phytopathogenic fungi or oomycetes, comprising the application to the vegetative growing apparatus of plants infected or liable to be infected by so-called type A strains of pathogenic endemic fungi or oomycetes, a composition comprising one or more type B strains, or type A by B offspring, said type A and type B strains being as previously defined.

Another object of the invention is a selection method for type B strains of phytopathogenic fungi or oomycetes which are non-pathogenic to the plant to be treated, in particular strains of Venturia inaequalis, suitable for use in a biocontrol method according to the invention for combating the spread of pathogenic strains on a plant of interest or a biocontrol composition according to the invention, comprising the following steps:

(1) the evaluation of their intrinsic capacity to saprophytically colonize apple leaves, in particular by means of the PCR or even quantitative PCR technique using primers specific to PYR strains,

(2) the evaluation of their ability to produce pseudothecia in the presence of type A strains, for example by carrying out crossbreeding in Petri dishes on autoclaved dead leaves, in particular according to the protocol described by Le Cam et al, 2002. “Evidence of two formae speciales in Venturia inaequalis, responsible for apple and Pyracantha scab”, Phytopathology 92:314-320.

According to another aspect, the invention also relates to an in vitro method for identifying and selecting Venturia inaequalis type B strains of special pyracantha-specific form (f. sp pyracantha or PYR), which can be used in a biocontrol method according to the invention or a biocontrol composition according to the invention for combating the spread of V. inaequalis pathogenic strains, in particular type A strains of special form f. sp pomi or POMI, comprising:
an extraction step for the DNA of Venturia inaequalis strains;
an amplification step by PCR or even by qPCR of specific nucleic sequences of the PYR strain genome, in particular of nucleic sequences comprising a nucleic sequence identical or having at least 90% or even at least 95% identity with one of the sequences SEQ ID NO:4 to SEQ ID NO:8, preferably the sequence SEQ ID NO: 5, by means of specific nucleic primers, in particular a forward primer of identical nucleic sequence or having at least 90% or even at least 95% identity with the sequence SEQ ID NO: 11 and a reverse primer of identical nucleic sequence or having at least 90% or even at least 95% identity with the sequence SEQ ID NO: 12;
and optionally a detection step of said amplified sequences by means of probes, preferably labelled with fluorophores.

The invention also relates to a kit for the detection of apple-specific type A Venturia inaequalis strains of special form (f. sp pomi or POMI) for use in a targeted biocontrol method according to the invention or an application of a biocontrol composition according to the invention, comprising a forward primer and a reverse primer comprising 12 to 30 nucleotides, preferably 15 to 25 nucleotides, respectively, and capable of amplifying by PCR a specific nucleic acid sequence of the POMI genome, in particular a nucleic acid sequence which is identical to or has at least 90%, or even at least 95%, identity with one of the sequences of SEQ ID NO: 1 to SEQ ID NO:3, preferably a forward primer with a nucleic sequence which is identical or has at least 90% or at least 95% identity with the sequence SEQ ID NO:9 or SEQ ID NO:17 and a reverse primer with a nucleic sequence which is identical or has at least 90% or even at least 95% identity with the sequence SEQ ID NO:10 or SEQ ID NO:18.

According to a particular embodiment, the present invention relates to a kit for the in vitro detection of PYR strains of opposite sexual signs and POMI strains, comprising primer nucleic acid sequences for the amplification of nucleic acid sequences specific to PYR and POMI respectively, comprising:
a) A pair of primer nucleic sequences comprising a sequence identical or having at least 90%, or even at least 95%, identity with the sequence SEQ ID NO: 9 or SEQ ID NO: 17 (forward primer), and a sequence identical or having at least 90%, or even at least 95%, identity with the sequence SEQ ID NO: 10 or SEQ ID NO:18 (reverse primer), in order to amplify by PCR or even by qPCR a POMI-specific nucleic sequence, and optionally in addition specific probes, preferably labelled with fluorophores, in order to detect said amplified sequences,
b) optionally also a pair of primer nucleic sequences comprising a sequence identical or having at least 90%, or even at least 95%, identity with the sequence SEQ ID NO: 11 or SEQ ID NO: 19 (forward primer) a sequence identical or having at least 90%, or even at least 95%, identity with the sequence SEQ ID NO: 12 or SEQ ID NO:20 (reverse primer), to amplify by PCR or qPCR a PYR-specific nucleic sequence, and optionally in addition specific probes, preferably labelled with fluorophores, to detect said amplified sequences, and
c) optionally also two pairs of primers respectively mat-α consisting of the sequences comprising a nucleic sequence identical or having at least 90% identity with the sequence SEQ ID NO: 13 (forward primer) and a nucleic sequence identical or having at least 90%, or even at least 95%, identity with the sequence SEQ ID NO: 14 (reverse primer) and mat-HMG consisting of the sequences comprising a nucleic sequence identical or having at least 90%, or even at least 95%, identity with the sequence SEQ ID NO: 15 (forward primer) and a nucleic sequence identical or having at least 95% identity with the sequence SEQ ID NO: 16 (reverse primer), to amplify sequences specific to the mating-type locus and to select the PYR strains of opposite sexual signs.

### Definitions

‘Biocontrol’ means a set of crop protection methods based on the use of living organisms (e.g. macro- or micro-organisms) or natural substances (e.g. pheromones, natural substances of mineral, plant or animal origin). In the context of the present invention, non-pathogenic strains of fungi or oomycetes are used which aim to interrupt the cycle of the fungus by forcing it to produce non-pathogenic or even sterile offspring. This may be referred to as a biocontrol method by sexual diversion during the senescence phase of the vegetative apparatus of plants.

‘Phyto-protection’ refers according to the invention, to a biological combat method for the protection of crops against infection by pathogenic fungi or oomycetes using mechanisms such as stimulation of the plant's defenses, antagonism, exclusion by occupation of the ecological niche, etc. . . . . In particular, the application of non-pathogenic type B strains according to the invention at the time of contamination during the vegetative growth phase of the plant makes it possible to reinforce the protection of the plant against infection by pathogenic type A strains.

‘Vegetative apparatus’ refers in particular to the leaves, stems and/or fruits. According to a particular embodiment of the invention, the composition of the invention is applied to the leaves. According to a preferred embodiment, the composition of the invention is applied to leaves in the vegetative growth phase in spring and summer for a phytoprotective effect and to senescent leaves in autumn for a biocontrol effect.

‘Phytopathogenic fungi’ refers to species of parasitic fungi that cause cryptogamic diseases in plants. These fungi belong to the different groups of the kingdom Eumycetes or ‘true fungi’: Ascomycetes, Basidiomycetes, Chytridiomycetes, Zygomycetes and Deuteromycetes (imperfect fungi). Phytopathogenic fungi are capable of infecting any tissue at any stage of plant growth, following a complex life cycle that may include sexual or asexual reproduction stages. The invention is particularly concerned with sexually reproducing or having the ability to reproduce sexually, phytopathogenic fungi.

Particularly noteworthy are Venturia inaequalis causing apple scab, Fusicladium effusum causing pecan scab, Venturia pirina causing pear scab, Zymoseptoria tritici causing septoria in wheat, Blumeria graminis causing oidium in wheat, Mycosphaerella fijiensis causing cercosporiose in banana tree, and Leptosphaeria maculans causing crown necrosis in oilseed rape.

‘Phytopathogenic oomycetes’ refers to parasitic filamentous eukaryotic organisms that cause fungal diseases in plants.

In particular, Plasmopara viticola, which causes downy mildew in grapes, and Phytophthora infestans, which causes downy mildew in potatoes and tomatoes, are mentioned.

‘Special forms’ or ‘divergent populations’ refers to the existence, within the same species of fungus or oomycete, of divergent forms or populations specifically pathogenic to a host plant. In the case of Venturia inaequalis, there is a form that specifically infects apple tree (f. sp pomi=POMI), and another that specifically infects pyracantha (f. sp pyracanthae=PYR). The special form of POMI is referred to as the apple-pathogenic strain (‘type A’ strain or pathogenic strain according to the invention) and the special form of PYR is referred to as the apple-nonpathogenic strain (‘type B’ strain or non-pathogenic strain according to the invention).

‘Sexual reproduction’ means that fungi or oomycetes reproduce sexually or have the ability to reproduce sexually when environmental conditions are met.

‘Sexual phase initiated in saprotrophic (or saprophytic) or non-parasitic mode’ means that the fungi or oomycetes are able to develop on senescent or dead plant tissues, so this phase is not parasitic.

‘Reproduction according to a heterothallic mode’ means according to the invention a sexual reproduction that can only take place between strains of fungi or oomycetes carrying an opposite sexual sign at the locus of the ‘mating type’. These strains of opposite sexual sign are called ‘compatible’.

‘Mixture of non-pathogenic fungi or oomycetes strains’ (‘Type B strains’ or non-pathogenic strains according to the invention) means a mixture of type B strains, compatible in crossbreeding (‘sexually compatible’) with the fungi or oomycetes strains of the same species but pathogenic on said plants (‘type A strains’). Mixing the different strains increases the chances of obtaining fertile crossbreeds (production of zygotes, in particular pseudothecia in the case of V. inaequalis) with the strains of pathogenic fungi or oomycetes resident on said plants and thus obtaining non-pathogenic or even non-fertile offspring strains. The mixture may comprise two or more different strains. In a particular and preferred embodiment, the mixture comprises strains of non-pathogenic fungi or oomycetes of the same species or of divergent sexually compatible populations of opposite sexual signs.

‘Divergent populations’ within a species means in particular that populations have evolved separately enough to have developed intrinsic biological characteristics, in particular to have a different host range. Thus, two divergent populations may specialize on different hosts.

According to the invention, it is also referred to as an inoculum of non-pathogenic fungal or oomycete strains, used in agriculture for the inoculation of the vegetative apparatus of the plants to be treated or of the culture substrates (soil and/or culture media of the plants to be treated).

‘Cross-compatible’ or ‘sexually compatible’ refers to the ability of two strains to crossbreed and produce a zygote (a pseudothecium in the case of V. inaequalis).

‘Opposite sexual signs’ means that the mixture includes ‘mat HMG’ and ‘mat Alpha Box’ strains respectively. The mat locus is the sexual identity locus in fungi that controls the sexual identity of cells and their development. The mat loci encode transcription factors Mat-HMG (for ‘high mobility group box’) or Mat-α (for ‘alpha box’), which coordinate the expression of sex-specific genes. In heterothallic fungi, the mat locus encodes one of two non-allelic (idiomorphic) sequences that occupy the same genetic position on homologous chromosomes of two sexually compatible strains, mat-HMG and mat-α (mat-alpha).

Fertilization occurs exclusively between mat-HMG and mat-α strains.

‘Resident pathogenic fungal or oomycete strains’ refers to endemic strains, naturally present on infected plants (‘Type A strains’ or pathogenic strains according to the invention).

### DESCRIPTION OF THE FIGURES

FIG. 1: Plant sensitivity of the known scab-sensitive Pyracantha variety ‘Kazan’ inoculated with each of the 38 offspring of the crossbreeding 1669 (PYR)×EUB04 (POMI) in a 27-day climate-controlled cell trial. The disease was scored at 15, 20, 23 and 27 days after inoculation of the offspring. At each time point, the average rating of the three most sensitive plant leaves was taken. The parental strains used as controls are placed at each end of the FIGURE.

Further characteristics, purposes and advantages of the invention will become apparent from the following description, which is purely illustrative and not limiting.

### DETAILED DESCRIPTION OF THE INVENTION

Biocontrol Method

A first object of the invention is therefore a biocontrol method for combating the spread of phytopathogenic fungi or oomycetes on plants, comprising the application, to the soil and/or to the vegetative apparatus of plants infected or liable to be infected by strains of pathogenic endemic fungi or oomycetes known as type A, a composition comprising a mixture of at least two strains, called type B, of the same species or of divergent populations within the species, said type B strains being non-pathogenic for said plant and sexually compatible with said pathogenic strains,

and characterized in that the mixture of non-pathogenic type B strains comprises strains of opposite sexual signs.

The biocontrol method according to the invention comprises in particular the application of a composition according to the invention on the soil and/or the vegetative apparatus of the plant during the senescence phase (e.g. autumn), in particular to senescent or dead leaves that have fallen on the soil.

Crossbreeding between pathogenic type A strains and non-pathogenic type B strains produces non-pathogenic or even sterile offspring in plants.

The type B strains are further characterized in that they have:
a) a sexual reproduction,
b) a sexual phase initiated in a non-parasitic mode,
c) a reproduction according to a heterothallic mode, and
d) the existence of special forms or divergent populations within the species, capable of producing, by crossbreeding with type A strains, non-pathogenic or even sterile offspring on said plant of interest.

According to a first embodiment, the biocontrol composition is applied to the vegetative apparatus in the senescence phase of said plants to be treated, in particular the dead leaves that have fallen on the soil.

According to another embodiment, the biocontrol composition is applied to the soil in the orchard.

In yet another embodiment, the biocontrol composition is applied to the vegetative apparatus and the soil of said plants to be treated.

The vegetative apparatus may be leaves, stems and/or fruits. According to a particular embodiment, the biocontrol composition is applied to senescing leaves, in particular dead leaves that have fallen on the soil.

In the case of Venturia inaequalis in particular, the biocontrol composition is applied to the senescing or dead leaves of the apple trees to be treated.

According to a particular embodiment, said phytopathogenic fungus whose spread is sought to be eradicated by the biocontrol method according to the invention is selected from the group consisting of: Venturia inaequalis responsible for apple scab, Zymoseptoria tritici (=Mycosphaerella graminicola) responsible for wheat septoria, Blumeria graminis responsible for wheat oidium, Mycosphaerella fijiensis responsible for banana cercosporiose, and Leptosphaeria maculans responsible for rapeseed crown necrosis.

According to another particular embodiment, said oomycete whose spread is sought to be eradicated by the biocontrol method according to the invention is selected from the group consisting of: Plasmopara viticola responsible for downy mildew of grapes, and Phytophthora infestans responsible for downy mildew of potatoes and tomatoes.

According to a particular and preferred embodiment, said phytopathogenic fungus whose spread is sought to be eradicated by the biocontrol method according to the invention is Venturia inaequalis responsible for apple scab.

Taking the example of apple tree, V. inaequalis systematically completes its life cycle with a sexual phase in winter. Sexual reproduction begins in autumn when the fungus develops in saprotrophic (or non-parasitic) mode on senescent leaves on which the meeting of two strains with opposite sexual signs leads to the production of a zygote called pseudothecium. In the spring, ascospores (spores resulting from sexual reproduction) expelled from the pseudothecia are the primary contaminants of apple trees.

According to the invention, the biocontrol method applied to Venturia inaequalis thus uses a composition applied to the vegetative apparatus of the apple tree, in particular to senescent leaves and to dead apple leaves that have fallen on the soil, comprising a mixture of non-pathogenic Venturia inaequalis type B strains of special pyracantha form (f. sp pyracantha or PYR) for non-pathogenic to apple tree and sexually compatible with the pathogenic Venturia inaequalis type A strains of special apple tree-specific form (f. sp pomi or POMI).

The massive application of PYR strains in autumn in the orchard on senescent and dead leaves would thus lead to crossbreeding between special forms within the species that will generate non-pathogenic or even sterile offspring on the apple tree. Thus, by applying PYR strains in the autumn, a collapse in the size of the pathogenic population (POMI) would be caused in the following spring.

A Combination of the Effects of Phytoprotection (During the Vegetative Growth Phase of the Plant) and Biocontrol (During the Senescence Phase of the Plant)

In addition, and as mentioned above, Venturia inaequalis initiates its parasitic cycle in the spring with the projection of ascospores responsible for the first scab spots on apple leaves and fruits, and continues with secondary contaminations initiated by conidia until the autumn contaminating leaves and fruits. In practice, the periods of fungicide applications by growers to protect apple trees is based on models whose main function is to predict ascospore projections over several months. Secondary infections are also protected by the application of fungicides. The Applicant has shown in the following illustrative examples under controlled conditions that pre-inoculation of PYR strains to a POMI inoculation on apple trees reduced the disease on Golden Delicious and Gala varieties. On the basis of this result, the present invention proposes to develop a new control method based on successive introductions of PYR strains or POMIxPYR offspring in the spring at the period of POMI ascospore projection instead of fungicides, or even in the summer if necessary until fruit harvest.

According to a particular embodiment of the invention, it will thus be possible to combine this ‘phytoprotective’ effect, which protects the plant from further infection, by applying PYR strains to the vegetative apparatus during its vegetative growth phase (in spring or even in summer), the ‘biocontrol’ effect which aims to interrupt the cycle of the fungus by forcing it to produce non-pathogenic PYRxPOMI hybrid offspring, by massive application of PYR strains on the soil and/or the vegetative apparatus in the senescence phase (autumn) which will crossbreed with the POMI infectious strains in the orchard. This combination of the two treatments would lead on the one hand to the production of non-pathogenic hybrid ascospores (autumn treatment) and on the other hand to a reinforcement of the protection of the apple tree by successive applications of PYR strains at the time of the spring contaminations predicted by the models.

The application of PYR strains in the autumn may lead in the spring to the production of ascospores from PYRxPOMI and PYRxPYR crossbreed, which are also expected to have a protective effect on apple tree following their projection onto young apple shoots. There would therefore be a double induced protection of apple tree, both by the PYR strains applied by spraying in spring and summer and by the projection of PYRxPOMI and PYRxPYR ascospores generated following the application of PYR in autumn. The naturally-projected ascospores in the spring would be synchronous with the POMI ascospores projected during rainfall and would therefore have the advantage of protecting at the time of risk of infection.

The invention is illustrated in a non-limiting way with PYR strains on apple trees but can be extrapolated to other non-pathogenic type B strains as defined in the invention.

According to a particular embodiment of the invention, the biocontrol composition according to the invention is applied by spreading, in particular by spraying on the vegetative apparatus of said plants and/or on the soil in orchards.

The dose to be applied will depend on the plants to be treated and the phytopathogenic fungus or oomycete to be eradicated. The person skilled in the art will thus adjust the dose to be used according to these conditions. In particular, the effective dose or concentration of non-pathogenic type B fungus or oomycete strains for the plant to be treated will generally range from 500 spores/ml to 600,000 spores/ml, in particular 5,000 to 400,000 spores/ml of composition applied to the plants to be treated.

In a particular and preferred embodiment, the biocontrol method for the spread of V. inaequalis pathogenic strains responsible for apple scab is implemented in autumn, after the harvest of the apples and before leaf fall.

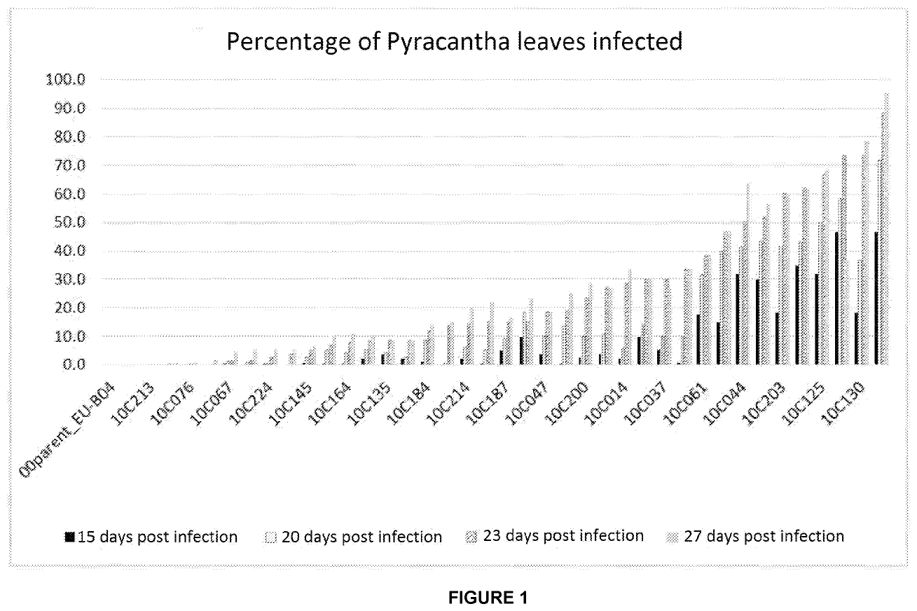

Thus, the PYR strains selected according to the invention as described below are inoculated in autumn on apple leaves sampled in the orchard. After winter incubation, the percentage of hybrid perithecia as well as the amount of disease generated by the ascospores produced are evaluated by inoculating them on apple trees under controlled conditions. The application of said PYR strains can thus be optimized by playing on different conditions, for example:
At different dates according to the key moments of leaf senescence in the autumn to optimize the application date of PYR;
With different PYR inocula (different mixtures of PYR, each mixture containing at least one PYR mat-HMG strain and one PYR mat-α strain to optimize the nature of the inoculum to be applied;
With PYRxPOMI offspring obtained in the laboratory and shown to be non-pathogenic on apple tree and pyracantha (see FIG. 1), each mixture containing at least one mat-HMG strain and one PYR mat-α strain.
With different application modes to optimize application conditions (different concentrations of PYR, different formulations—presence of different types of adjuvants or not, spores encapsulated in microbeads or not).

The person skilled in the art thus selects the condition which allows the greatest number of hybrid pseudotheces and the absence of disease to be obtained.

The biocontrol method according to the invention, illustrated in the examples described below for V. inaequalis, can be transposed to other phytopathogenic fungi or oomycetes to protect other crops, provided that said phytopathogenic fungi or oomycetes satisfy the following 4 criteria
a sexual reproduction step,
a sexual phase initiated in a non-parasitic mode,
a reproduction according to a heterothallic mode,
the existence of special forms within the species—or sexually compatible divergent populations—of a phytopathogenic fungus or oomycete, whose crossbreed between type B strains that are non-pathogenic to the plant to be treated and type A strains that are pathogenic and endemic to the plant to be treated, produce offspring that are non-pathogenic to said plant, or even sterile.

Biocontrol Composition and Phytoprotection Composition

According to the invention, the terms ‘biocontrol composition’ or ‘biocontrol preparation’ are used interchangeably in the description.

The present invention thus also relates to a biocontrol composition comprising at least one mixture of sexually opposite type B strains of a phytopathogenic fungus or oomycete non-pathogenic for the plant to be treated and sexually compatible in crossbreeding with type A strains of the same or related species but pathogenic and endemic to the plant to be treated.

Thus, said type B strains have special forms within the species or sexually compatible divergent populations, non-pathogenic to the plant but compatible in crossbreeding with type A strains of the same species but pathogenic to the plant, allowing the production of offspring non-pathogenic to said plant or even sterile.

According to a particular embodiment, said biocontrol composition comprises at least a mixture of Venturia inaequalis type B strains of the special pyracantha (specific) form (f. sp pyracantha or PYR) which are non-pathogenic to apple tree and sexually compatible with Venturia inaequalis type A strains of the special apple tree-specific form (f. sp pomi or POMI).

Examples of such PYR strains for use in the biocontrol method or biocontrol composition according to the invention are described below.

Preferably, said composition comprises a mixture of the V. pyra 1669 strain deposited at the CNCM under the No. CNCM I-5456 and the V. pyra 2507 strain deposited at the CNCM under the No. CNCM I-5457.

These two strains of filamentous fungi were deposited, under the terms of the Budapest Treaty, on Nov. 21, 2019, at the Collection Nationale Des Cultures de micro-organismes (CNCM) of the Institut Pasteur, 25 rue du Docteur Roux, 75724 Paris Cedex 15), on behalf of the Institut national de la recherche agronomique—I.N.R.A., 147 rue de l'université, 75338 Paris Cedex 07.

According to another particular and preferred embodiment, the composition of the invention comprises a mixture of the V. pyra 1381 strain deposited at the CNCM under the No. CNCM I-5627 and the V. pyra 1387 strain deposited at the CNCM under the No. CNCM I-5629, or a mixture of the V. pyra 1381 strain and the V. pyra 2299 strain deposited at the CNCM under the No. CNCM I-5630, or a mixture of the V. pyra 1386 strain deposited at the CNCM under the No. CNCM I-5628 and the V. pyra 1387 strain deposited at the CNCM under the No. CNCM I-5629, or a mixture of the V. pyra 1386 strain and the V. pyra 2299 strain deposited at the CNCM under the No. CNCM I-5630.

According to a particular and preferred embodiment, the biocontrol composition according to the invention comprises a mixture of strains of opposite sexual signs of a phytopathogenic fungus or oomycete of type B non-pathogenic for the plant to be treated, in particular a mixture of PYR strains of opposite sexual signs, in a concentration ranging from 500 spores/ml to 600,000 spores/mL, in particular 5,000 to 400,000 spores/mL.

The biocontrol composition may further comprise adjuvants conventionally used in the formulation of biocontrol products. These adjuvants may in particular be chosen from the group consisting of wetting agents, adhesive agents, water retaining agents, emulsifiers, and mixtures thereof. These adjuvants facilitate the homogenization of the composition, the adhesion of the strains to the vegetative apparatus, the resistance of the strains to leaching and even their germination.

According to a particular embodiment, the composition will contain at least 2 PYR strains of opposite sexual signs and non-pathogenic for the apple tree, with a final concentration of between 5,000 spores/ml and 600,000 spores per milliliter (ml), in particular 5,000 to 400,000 spores/ml of biocontrol composition, and optionally one or more adjuvants chosen from wetting agents, adhesive agents, water retaining agents, emulsifiers, and mixtures thereof.

Examples of wetting agents are a mixture of methyl ester and dioctyl sulphoccinate or alkyl glucoside ester citrate, esterified vegetable or mineral oils. Carboxy methyl cellulose may be mentioned as an adhesive agent. Guar gum may be used as a water retention agent. As an example of an emulsifying agent, sorbitol derivatives may be mentioned.

The person skilled in the art will adapt the choice of adjuvants and their contents in the biocontrol composition, depending in particular on the plants to be treated and the modes of application.

According to a particular embodiment, the biocontrol composition is applied by spreading, in particular by spraying on said plants, and in particular by spraying on the vegetative apparatus of said plants and/or on the soil in orchards.

According to a preferred embodiment, the biocontrol composition will be applied by means of a sprayer, a device conventionally used in arboriculture which allows excellent dispersion of the preparations over the entire plant cover.

The ‘phytoprotection’ composition according to the invention will comprise one or more type B strains according to the invention, or type A by B offspring, in particular one or more Venturia inaequalis type B strains of the special pyracantha form (f. sp pyracantha or PYR), preferably selected from the group consisting of the V. pyra 1669 strain deposited at the CNCM under the No. CNCM I-5456, the V. pyra 2507 strain deposited at the CNCM under the No. I-5457, the V. pyra 1381 strain deposited at the CNCM under the No. CNCM I-5627, the V. pyra 1387 strain deposited at the CNCM under the No. CNCM I-5629, the V. pyra 2299 strain deposited at the CNCM under the No. CNCM I-5630, the V. pyra 1386 strain deposited at the CNCM under the No. CNCM I-5628, and their mixtures as defined above for the biocontrol composition, or PYRxPOMI offspring.

According to a particular and preferred embodiment, the phytoprotection composition according to the invention comprises one or more PYR strains, or PYRxPOMI offspring, in a concentration ranging from 500 spores/ml to 600,000 spores/ml, in particular 5,000 to 400,000 spores/ml.

The phytoprotection composition may further comprise adjuvants as described above for the biocontrol composition.

According to a particular embodiment, the phytoprotection composition is applied by spreading, in particular by spraying on said plants, and in particular by spraying on the vegetative apparatus in the vegetative growth phase of said plants.

Selection of Fungal or Oomycete Strains for Use as Non-Pathogenic Type B Strains in the Biocontrol Method or Composition According to the Invention

According to the invention, this selection method of type B strains of phytopathogenic fungus or oomycete, which are non-pathogenic for the plant to be treated but sexually compatible by crossbreeding with type A strains of the same species but pathogenic and endemic for the plant to be treated, comprises a pre-selection step of the strains characterized by:
a) a sexual reproduction step,
b) a sexual phase initiated in a non-parasitic mode,
c) a reproduction according to a heterothallic mode, and
d) the existence of special forms within the species or sexually compatible divergent populations, whose crossbreed with pathogenic strains of the same species (‘type A’ strains) produce non-pathogenic or even sterile offspring on the plant of interest.

We speak of fungal or oomycete strains within the same fungal or oomycete species (e.g. Venturia inaequalis), but of special forms specific to a plant (e.g. apple tree or pyracantha respectively), with type B strains and type A strains of the same fungal or oomycete species having special forms for pyracantha and apple tree respectively.

Selection Method of Strains of Interest and Analysis of Offspring (Method 1)

In a first method, non-pathogenic strains of interest are selected for apple tree by crossbreeding with apple tree pathogenic strains, observing fertile crossbreed (production of pseudothecia), analyzing non-pathogenic offspring and selecting non-pathogenic PYRxPOMI offspring on apple tree and pyracantha.

This selection can be done by crossbreeding PYR strains with POMI strains and observing fertile crossbreed (production of pseudothecia).

The PYR strains that can be used in the biocontrol method or composition according to the invention are selected from PYR strains isolated from Pyracantha leaves infected by V. inaequalis and called ‘PYR’ strains or from collections of strains accessible to the scientific community.

Examples include the PYR strains listed in the following Table 1:

| ID | Name | Species | Country | Year | Population | Host | Reference |
|---|---|---|---|---|---|---|---|
| 186 | Vina_186_pyr | V. inaequalis | Ireland | 1987 | PYR | Pyracantha | Le Cam et al. |
| | | | | | | ‘Red Colum’ | 2002 |
| | | | | | | | Le Cam et |
| | | | | | | | al., 2019 |
| 1381 | Vina-1381_pyr | V. inaequalis | France | 1998 | PYR | Pyracantha | Le Cam et al. |
| | | | | | | | 2002 |
| 1383 | Vina-1383_pyr | V. inaequalis | France | 1998 | PYR | Pyracantha | Le Cam et al. |
| | | | | | | | 2002 |
| 1386 | Vina-1386_pyr | V. inaequalis | France | 1998 | PYR | Pyracantha | published |
| 1387 | Vina-1387_pyr | V. inaequalis | France | 1998 | PYR | Pyracantha | Unpublished |
| 1388 | Vina-1388_pyr | V. inaequalis | France | 1998 | PYR | Pyracantha | Le Cam et al. |
| | | | | | | | 2002 |
| 1669 | Vina_1669_pyr | V. inaequalis | USA, | 2001 | PYR | Pyracantha | Gladieux et |
| | | | KY | | | | al. 2010a ; Le |
| | | | | | | | Cam et al., |
| | | | | | | | 2019 |
| 2266 | Vina_2266_pyr | V. inaequalis | France | 1993 | PYR | Pyracantha | Gladieux et |
| | | | | | | ‘Mohave’ | al. 2010a ; Le |
| | | | | | | | Cam et al., |
| | | | | | | | 2019 |
| 2269 | Vina_2269_pyr | V. inaequalis | Sweden | 2003 | PYR | Pyracantha | Gladieux et |
| | | | | | | | al. 2010a ; Le |
| | | | | | | | Cam et al., |
| | | | | | | | 2019 |
| 2507 | Vina_2507_pyr | V. inaequalis | Chili | 2004 | PYR | Pyracantha | Gladieux et |
| | | | | | | coccinea | al. 2010a ; Le |
| | | | | | | | Cam et al., |
| | | | | | | | 2019 |
| 2299 | Vina2299_pyr | V. inaequalis | France | 2004 | PYR | Pyracantha | Unpublished |

According to a particular embodiment of the invention, the following may be mentioned
the Vina_1669_pyr strain also named V. pyra 1669 deposited on behalf of INRA on Nov. 21, 2019 at the CNCM at the Institut Pasteur, 25 rue du Docteur Roux, 75724 Paris Cedex 15 under the No. CNCM I-5456,
the Vina_2507_pyr strain also named V. pyra 2507 deposited on behalf of INRA on Nov. 21, 2019 at the CNCM at the Institut Pasteur, 25 rue du Docteur Roux, 75724 Paris Cedex 15 under the number C-CNCM I-5457,
the Vina_1381_pyr strain also named V. pyra 1381 deposited on behalf of INRAE on Dec. 11, 2020 at the CNCM at the Institut Pasteur, 25 rue du Docteur Roux, 75724 Paris Cedex 15 under the No. CNCM I-5627,
the Vina_1386_pyr strain also named V. pyra 1386 deposited on behalf of INRAE on Dec. 11, 2020 at the CNCM at the Institut Pasteur, 25 rue du Docteur Roux, 75724 Paris Cedex 15 under the No. CNCM I-5628,
the Vina_1387_pyr strain also named V. pyra 1387 deposited on behalf of INRAE on Dec. 11, 2020 at the CNCM at the Institut Pasteur, 25 rue du Docteur Roux, 75724 Paris Cedex 15 under the No. CNCM I-5629,
the Vina_2299_pyr strain also named V. pyra 2299 deposited on behalf of INRAE on Dec. 11, 2020 at the CNCM at the Institut Pasteur, 25 rue du Docteur Roux, 75724 Paris Cedex 15 under the No. CNCM I-5630,
and mixtures thereof.

The following table shows the sexual type of each of the above 6 strains:

| Name of | Name of CNCM | Sexual |
|---|---|---|
| PYR strain | Collection | Type |
| 1381 | CNCM I-5627 | mat HMG |
| 1386 | CNCM I-5628 | mat HMG |
| 1669 | CNCM I-5456 | mat HMG |
| 1387 | CNCM I-5629 | mat α |
| 2299 | CNCM I-5630 | mat α |
| 2507 | CNCM I-5457 | mat α |

The biocontrol method or the phytoprotection composition according to the invention may use a mixture of two strains among those listed in Table 2, of opposite sexual signs. All combinations are possible, and it is advantageous to choose the strains 1381 and 1386 (mat HMG) combined with the strains 1387 and 2299 (mat alpha), i.e. the mixtures 1381/1387, 1381/2299, 1386/1387 and 1386/2299.

Among the available PYR strains, the PYR strains used according to the biocontrol method or the composition of the invention are selected according to two criteria: saprotrophic (non-parasitic) growth on apple leaf litter, and the aptitude for sexual reproduction with POMI strains.

Thus, according to a particular embodiment, PYR strains of Venturia inaequalis not pathogenic for apple trees (so-called ‘type B’ strains), but sexually compatible with POMI strains of Venturia inaequalis that are pathogenic for apple trees (‘type A’ strains), are selected, which can be used in a biocontrol method according to the invention or a biocontrol composition according to the invention.

Said PYR strains are selected according to the following steps:
a) The ability of said PYR strains to multiply in vitro and produce spores, e.g. on agar medium with or without cellophane sheet,
b) The intrinsic ability of said PYR strains to colonize apple leaves in the saprophytic form, by inoculating scab-free, non-fungicide-treated leaves with PYR strains (strain by strain) and assessing the colonization of each strain, e.g. by PCR or even qPCR (quantitative PCR),
c) The ability of said PYR strains to reproduce sexually with POMI strains, in particular by crossbreeding and counting the number of pseudothecia produced,
d) The ability of said PYR strains to reproduce sexually in a situation of competition between POMI strains and the strains to be tested, in particular by mixing mat-HMG and mat-α strains and evaluating the number of pseudotheces and the percentage of hybrid pseudotheces, for example by PCR or even qPCR;
e) The ability of said PYR strains to produce non-pathogenic offspring resulting from crossbreeding between POMI strains and the strains to be tested, in particular by isolating the ascospores produced and phenotyping the offspring on apple grafted plants or apple seedlings under controlled conditions.

In addition to sexual sign typing, the ability of PYR strains to multiply in vitro (step a)) is performed as follows:
Kinetics of mycelial growth in vitro (on agar or in liquid medium)
Evaluation of sporulation in vitro (on cellophane sheets placed on a Petri dish).

The intrinsic ability of the strains to colonize apple leaves in the saprophytic form (step b)) is carried out as follows:
Harvesting leaves from scab-free orchards not treated with fungicides,
Inoculation of leaves with PYR strains (strain by strain),
Incubation under controlled conditions in a screened cage outdoors (autumn weather conditions), and
Evaluation of the colonization of each strain by PCR or qPCR.

The evaluation of PYR strains for their ability to reproduce sexually with POMI strains (step c)) can be performed as follows:
Crossbreeding between each PYR strain and POMI strains (mixtures of mat-HMG strains or mixtures of mat-α strains depending on the sexual sign of the PYR strain)
Comparison of the number of pseudothecia produced by the different PYR strains by counting pseudothecia

POMI strains are derived from POMI strains isolated from apple leaves infected with V. inaequalis and referred to as ‘POMI’ strains or from strain collections available to the scientific community.

Examples include the POMI strains listed in the following Table 3. The genome of all these strains has been published (Le Cam et al., 2019):

| ID | Name | Species | Country | Year | Population | Host | Reference |
|---|---|---|---|---|---|---|---|
| 104 | Vina_104_domEU | V. inaequalis | France | 1978 | domEU | Malus x | Bénaouf and |
| | | | | | | domestica | Parisi 2000 |
| | | | | | | ‘Golden’ | |
| 301 | Vina_301_domEU | V. inaequalis | Germany | 1988 | domEU | Malus x | Bénaouf and |
| | | | | | | domestica | Parisi 2000 |
| | | | | | | ‘81/19-53’ | |
| 2492 | Vina_2492_domEU | V. inaequalis | France | 2003 | domEU | Malus x | Lemaire et al., |
| | | | | | | domestica | 2016 |
| | | | | | | ‘Judor’ | |
| 2498 | Vina_2498_domEU | V. inaequalis | Sweden | 2005 | domEU | Malus x | Gladieux et al. |
| | | | | | | domestica ‘Gala’ | 2008 |
| 2499 | Vina_2499_domEU | V. inaequalis | Spain | 2005 | domEU | Malus x | Gladieux et al. |
| | | | | | | domestica | 2008 |
| | | | | | | ‘Golden’ | |
| EUB04 | Vina_EUB04_domEU | V. inaequalis | Belgium | 1998 | domEU | Malus x | Parisi et al., 2004 |
| | | | | | | domestica | |
| | | | | | | ‘Golden’ | |
| 1680 | Vina_1680_RVI6 | V. inaequalis | France | 2001 | domRvi6 | Malus x | Caffier et al., |
| | | | | | | domestica | 2015 |
| | | | | | | ‘Judeline’ | |
| 2199 | Vina_2199_RVI6 | V. inaequalis | Denmark | 2003 | domRvi6 | Malus x | Caffier et al., |
| | | | | | | domestica | 2015 |
| | | | | | | ‘Florina’ | |
| EU- | Vina_EUNL24_RVI6 | V. inaequalis | NetherLands | 1998 | domRvi6 | Malus x | Parisi et al., 2004 |
| NL24 | | | | | | domestica | |
| | | | | | | ‘Prima’ | |

In a second step, the ability to reproduce sexually in a competitive situation between POMI and PYR strains (step d)) is assessed, for example according to the following protocol:
Production of a PYR GFP strain to follow the installation of the fungus in the apple leaf in comparison with a POMI GFP strain, by fluorescence microscopy, or advantageously by PCR or even qPCR (quantitative PCR) specific to each special form to evaluate the relative biomass of each strain.
Carrying out different crossbreeds each involving 4 strains in a mixture (1 PYR mat-HMG strain, 1 PYR mat-α strain, 1 POMI mat-HMG strain, 1 POMI mat-α strain)
Evaluation of the number of pseudothecia and the percentage of hybrid pseudothecia by PCR or qPCR.

Finally, the non-pathogenicity of offspring from crossbreeding between PYR and POMI (step e)) can be analyzed on a large number of strains in order to document the likelihood of generating potentially pathogenic offspring on apple trees, notably by:
Isolation of ascospores produced during crossbreeding between PYR strains and POMI strains (50 ascospores per crossbreed),
Phenotyping of offspring on grafted apple plants in a climate chamber at 18° C. under controlled conditions up to 27 days after inoculation according to the protocol described by Le Van et al., 2012 Evolutionary applications)

PYR strains were selected which were shown to be able to crossbreed with POMI strains and produce non-pathogenic progeny on apple.

According to a particular embodiment, the biocontrol or phytoprotection method or composition of the invention will use the PYR 1669 (Vina_1669_pyr) strain, the V. pyra 2507 strain, the V. pyra1381 strain, the V. pyra 1386 strain, the V. pyra 1387 strain, the V. pyra 2299 strain, and their 2 by 2 mixtures according to their sexual signs (mixtures of strains of opposite sexual signs).

The characteristics of strains V. pyra 1669, V. pyra 2507, V. pyra 1381, V. pyra 1386, V. pyra 1387 and V. pyra 2299 are presented in Tables 1 and 2.

Strains 1381 and 1386 (mat HMG) in combination with strains 1387 and 2299 (mat alpha) are preferred.

According to another particular embodiment, one uses a V. pyra 1669 strain deposited at the CNCM under the No. CNCM I-5456, a V. pyra 2507 strain deposited at the CNCM under the No. CNCM I-5457, and preferably a mixture of these two strains, of opposite sexual signs.

According to another particular embodiment, a V. pyra 1381 strain deposited at the CNCM under the No. CNCM I-5627, a V. pyra 1387 strain deposited at the CNCM under the No. CNCM I-5629, and preferably a mixture of these two strains, of opposite sexual signs, are used.

According to another particular embodiment, a V. pyra 1381 strain deposited at the CNCM under the No. CNCM I-5627, a V. pyra 2299 strain deposited at the CNCM under the No. CNCM I-5630, and preferably a mixture of these two strains, of opposite sexual signs, are used.

According to another particular embodiment, a V. pyra 1386 strain deposited at the CNCM under the No. CNCM I-5628, a V. pyra 1387 strain deposited at the CNCM under the No. CNCM I-5629, and preferably a mixture of these two strains, of opposite sexual signs, are used.

According to another particular embodiment, a V. pyra 1386 strain deposited at the CNCM under the No. CNCM I-5628, a V. pyra 2299 strain deposited at the CNCM under the No. CNCM I-5630, and preferably a mixture of these two strains, of opposite sexual signs, are used.

According to a particular embodiment of the invention, the PYR strains are cultivated at 18° C. on cellophane membranes placed on Petri dishes containing a PDA-YE agar medium (PotatoDextrose Agar, BD Difco) supplemented with 0.3% yeast extract (Sigma-Aldrich) with a 12 h/12 h day/night alternation. They are stored both under liquid nitrogen and at −20° C. on dehydrated cellophane membranes in the Venturia collection of the Institut de Recherche en Horticulture et Semences (IRHS-INRA, Beaucouzé, France).

And the PYRxPOMI offspring obtained in the laboratory which have been shown to be non-pathogenic on apple tree and pyracantha are selected (see FIG. 1), each mixture comprising at least one mat-HMG strain and one PYR mat-α strain.

Selection Method for Non-Pathogenic Strains of Interest for Apple Tree by PCR Analysis (Method 2 as an Alternative to Method 1)

Advantageously and alternatively to the first method described above, the selection of PYR strains capable of crossbreed with POMI strains can be done by specific amplification of the allele at the mat locus, by PCR.

Thus another object of the invention is a selection method for type B strains of phytopathogenic fungi or oomycetes not pathogenic for the plant to be treated, in particular Venturia inaequalis strains, suitable for use in a biocontrol method according to the invention for combating the spread of pathogenic strains on a plant of interest or a biocontrol composition according to the invention, comprising the following steps:

(1) evaluation of their intrinsic ability to saprophytically colonize apple leaves, in particular by means of quantitative PCR using PYR strain-specific primers,

(2) evaluation of their ability to produce pseudotheces in the presence of type A strains, for example by carrying out crossbreeding in Petri dishes on autoclaved dead leaves, in particular according to the protocol described by Le Cam et al, 2002. “Evidence of two formae speciales in Venturia inaequalis, responsible for apple and Pyracantha scab”, Phytopathology 92:314-320.

In a first step, PYR strains are selected from V. inaequalis strains.

PYR and POMI strains are host specific. The host isolation (Apple tree or Pyracantha) can therefore be used to determine whether it is a PYR or POMI strain.

The Applicant has identified nucleotide sequences specific to each special form that distinguish PYR strains from POMI strains. In particular, he has identified nucleic acid sequences specific to POMI, not present in PYR, illustrated in the following table by the sequences SEQ ID NO: 1 to SEQ ID NO: 3, and respectively nucleic acid sequences specific to PYR, not present in POMI, illustrated in the following table by the sequences SEQ ID NO: 4 to SEQ ID NO: 8

The nucleic acid sequences are referenced in the following tables 4 and 5:

Nucleic acid sequences specific to POMI or PYR respectively

| | | | Size (number |
|---|---|---|---|
| SEQ ID NO | Genbank Reference | Source Agency | of nucleotides) |
| SEQ ID NO: 1 | Vina_EUB04.g9008 | V. inaequalis sf sp | 625 |
| | | pomi EUB04 | |
| SEQ ID NO: 2 | Vina_EUB04.g12572 | V. inaequalis sf sp | 363 |
| | | pomi EUB04 | |
| SEQ ID NO: 3 | Vina_EUB04.g13513 | V. inaequalis sf sp | 419 |
| | | pomi EUB04 | |
| SEQ ID NO: 4 | Vina_1669.g9937 | V. inaequalis sf sp | 477 |
| | | pyracanthae 1669 | |
| SEQ ID NO: 5 | Vina_1669.g9936 | V. inaequalis sf sp | 191 |
| | | pyracanthae 1669 | |
| SEQ ID NO: 6 | Vina_1669.g7519 | V. inaequalis sf sp | 1995 |
| | | pyracanthae 1669 | |
| SEQ ID NO: 7 | Vina_1669.g3689 | V. inaequalis sf sp | 222 |
| | | pyracanthae 1669 | |
| SEQ ID NO: 8 | Vina_1669.g3422 | V. inaequalis sf sp | 1239 |
| | | pyracanthae 1669 | |

The person skilled in the art will thus be able to define specific PCR or qPCR primers making it possible to amplify a specific fragment of POMI emitting in particular a FAM fluorescence according to the Taqman technique, or respectively a specific fragment of PYR emitting in particular a CYR fluorescence according to the Taqman technique.

In a particular and preferred embodiment, POMI primers defined from a sequence identical or having at least 90% or even at least 95% identity with the sequence of SEQ ID NO:1 of the g9008 gene are used. The primers generally comprise from 12 to 30 nucleotides, in particular from 15 to 25 nucleotides.

In a particular and preferred embodiment, PYR primers defined from a sequence having 100% identity with the sequence of SEQ ID NO: 5 of the Vina_669.g9936_fragment gene are used.

Such primers are presented in Tables 5 and 6:

Primers for PCRs

| | | | Size |
|---|---|---|---|
| | | | (number |
| | | | of nucleo- |
| SEQ ID NO | Primer | Source Agency | tides) |
| SEQ ID NO: 9 | spPomi-F | V. inaequalis sf sp pomi EUB04 | 20 |
| SEQ ID NO: 10 | spPomi-R | V. inaequalis sf sp pomi EUB04 | 20 |
| SEQ ID NO: 11 | spPyr-F | V. inaequalis sf sp pyracanthae | 19 |
| | | 1669 | |
| SEQ ID NO: 12 | spPyr-R | V. inaequalis sf sp pyracanthae | 20 |
| | | 1669 | |
| SEQ ID NO: 13 | mat-a-F | V. inaequalis sf sp pomi MNH120 | 20 |
| SEQ ID NO: 14 | mat-a-R | V. inaequalis sf sp pomi MNH120 | 20 |
| SEQ ID NO: 15 | mat- | V. inaequalis sf sp pomi 1639 | 20 |
| | HMG-F | | |
| SEQ ID NO: 16 | mat- | V. inaequalis sf sp pomi 1639 | 20 |
| | HMG-R | | |

| | | | Size |
|---|---|---|---|
| | qPCR | | (number of |
| SEQ ID NO | Primer | Source Agency | nucleotides) |
| SEQ ID NO: 17 | spPomi-F | Vina_EUB04.g9008_spPomi | 20 |
| SEQ ID NO: 18 | spPomi-R | Vina_EUB04.g9008_spPomi | 20 |
| SEQ ID NO: 19 | spPyr-F | Vina_1669.g9936_spPyr | 20 |
| SEQ ID NO: 20 | spPyr-R | Vina_1669.g9936_spPyr | 20 |

The identity percentages referred to in the context of the present invention are determined after optimal alignment of the sequences to be compared, which may therefore include one or more additions, deletions, truncations and/or substitutions.

This percentage identity can be calculated by any sequence analysis method well known to the person skilled in the art.

The percentage identity can be determined after global alignment of the sequences to be compared in their integrality, over their entire length. In addition to manual determination, it is possible to determine the global alignment of sequences using the algorithm of Needleman and Wunsch (1970).

For nucleotide sequences, the comparison of sequences can be carried out using any software well known to the person skilled in the art, such as Needle software. The parameters used can be the following: “Gap Open” equal to 10.0, “Gap Extend” equal to 0.5 and the EDNAFULL matrix (EMBOSS version of NCBI NUC4.4).

Preferably, the percentage identity defined in the context of the present invention is determined by means of a global alignment of the sequences to be compared over their entire length.

PCR or qPCR primers can thus be defined from said sequences, allowing each of the special forms to be specifically amplified, for use in an identification or detection tool. According to the Taqman technique, the presence of a probe specific to each special form will release a different fluorescence allowing the quantification of the DNA of each special form in the sample.

In one particular embodiment, the following PCR primers are used:

POMI specific PCR primers (Vina_EUB04.g9008_
spPomi, expected amplicon size = 163 bp)
spPomi-F Forward primer
(SEQ ID NO: 9)
GTTATGTCTGGCCGCGTTAT
spPomi-R Reverse primer
(SEQ ID NO: 10)
AGAAAAGCTGGCACCTCGTA
PYR specific PCR primers (Vina_1669.g9936_spPyr,
expected amplicon size = 157 pb)
spPyr-F Forward primer
(SEQ ID NO: 11)
CAAGCGAGCTGAAATCGAG
spPyr-R Reverse primer
(SEQ ID NO: 12)
GTACAACCCGATCCCTTTTG
In another particular embodiment, the following
qPCR primers are used: POMI-specific qPCR primers
(Vina_EUB04.g9008_spPomi, expected amplicon size =
135 pb)
spPomi-F Forward primer
(SEQ ID NO: 17)
AAAGGTCCCCTCACGAATAC
spPomi-R Reverse primer
(SEQ ID NO: 18)
GATCTGTTTCCCTTCCACCT
Sequence of the POM/-specific labelled probe [FAM]
(SEQ ID NO: 21)
TGCCATCTGGATCGGAACAA[BHQ3]
PYR-specific qPCR primers (Vina_1669.g9936_spPyr,
expected amplicon size = 85 pb)
spPyr-F Forward primer
(SEQ ID NO: 19)
GAGTTATTGCTGAGGCCAAG
spPyr-R Reverse primer
(SEQ ID NO: 20)
GCCTTGACTGTGCTCGTAAC
Sequence of the PYR-specific labelled probe:
(SEQ ID NO: 22)
[CY5]GCTCCAACCGTTGGTGGAGA[BBQ3].

In a particular embodiment, the detection method for PYR strains or POMI strains within V. inaequalis strains comprises the following steps:
a) extraction of DNA from V. inaequalis strains
b) denaturation of said extracted DNA
c) use of sense (forward) and antisense (“reverse”) primers for the amplification of POMI-specific nucleic acid sequences such as a sequence comprising a nucleic acid sequence which is identical or has at least 90% or even at least 95% identity with one of the sequences SEQ ID NO: 1 to SEQ ID NO:3 or a fragment thereof, or amplification of PYR-specific nucleic acid sequences such as a sequence comprising a nucleic acid sequence identical or having at least 90% identity with one of the sequences SEQ ID NO:4 to SEQ ID NO:8 or a fragment thereof, and
d) optionally use of specific probes, advantageously labelled with fluorophores to detect said amplified nucleic sequences or fragments thereof, allowing the categorization of POMI strains and PYR strains.

‘Nucleic sequence fragment’ refers to a fragment comprising 8 to 30 nucleotides, in particular 15 to 25 nucleotides.

The invention further relates to an in vitro selection method for Venturia inaequalis type B strains of the special pyracantha-specific form (f. sp pyracantha or PYR), which can be used in a biocontrol method according to the invention or a biocontrol composition according to the invention for combating the spread of pathogenic V. inaequalis strains, in particular special form type A strains f. sp pomi or POMI, comprising:
an extraction step for the DNA of Venturia inaequalis strains;
a PCR or qPCR amplification step of specific nucleic sequences of the genome of the PYR strains, in particular nucleic sequences comprising a nucleic sequence identical or having at least 90% or even at least 95% identity with one of the sequences SEQ ID NO:4 to SEQ ID NO:8, preferably the sequence SEQ ID NO: 5, by means of specific nucleic primers, in particular a forward primer of nucleic sequence identical or having at least 90% or even at least 95% identity with the sequence SEQ ID NO: 11 or SEQ ID NO: 19 and a reverse primer of nucleic sequence identical or having at least 90% or even at least 95% identity with the sequence SEQ ID NO: 12 or SEQ ID NO: 20; and
optionally a detection step of said amplified sequences by means of probes, preferably labelled with fluorophores.

The extraction of nucleic acids from a biological sample can be done by conventional methods known to the person skilled in the art, as described in Maniatis T. et al (1999 Edition).

‘Nucleic acid denaturation” refers to the step in which complementary nucleic acid strands are dissociated. Double-stranded nucleic acid molecules are formed by non-covalent association through hydrogen bonds between complementary nucleotides, denaturation of the nucleic acid occurs by breaking said hydrogen bonds. The conditions for inducing denaturation and renaturation will be readily determined by the person skilled in the art. In a method according to the invention, the denaturation induction of double-stranded nucleic acid molecules can be achieved by any method subjecting nucleic acids to any physical or chemical agent capable of destabilizing hydrogen bonds, such as high temperature.

Nucleic acid denaturation is reversible, when denaturation has been induced by raising the temperature, a temperature cooling step allows for renaturation, in which the complementary strands reassemble with hydrogen bonds.

In a particular embodiment, a forward primer comprising a sequence which is identical or at least 90% or even at least 95% identical to the nucleic acid sequence SEQ ID NO:9 or SEQ ID NO:17 and a reverse primer comprising a sequence which is identical or at least 90% or even at least 95% identical to the nucleic acid sequence SEQ ID NO:10 or SEQ ID NO:18 are used to amplify POMI-specific nucleic acid sequence fragments.

In a particular embodiment, a forward primer comprising a sequence which is identical or at least 90% or even at least 95% identical to the nucleic acid sequence SEQ ID NO: 11 or SEQ ID NO:19 and a reverse primer comprising a sequence which is identical or at least 90% or even at least 95% identical to the nucleic acid sequence SEQ ID NO:12 or SEQ ID NO:20 are used to amplify PYR-specific nucleic acid sequence fragments.

In a particular embodiment, the conditions for locus-specific amplification of the POMI form and the PYR form are as follows: 2 minutes denaturation of V. inaequalis DNA at 95° C. followed by 35 cycles comprising 30 seconds at 95° C., 30 seconds at 60° C., 30 seconds at 72° C. followed by a final extension phase at 72° C. for 5 minutes.

A detection (or identification) tool can thus be developed to detect PYR strains in relation to POMI strains, using the sequences specific to the special PYR form among those described above, and from among the PYR strains, select, as described below, PYR strains of opposite sexual signs which can be used in a biocontrol method or composition according to the invention.

Thus, in a second step of the method, PYR strains of opposite sexual signs are selected.

The sexual sign of each PYR strain can be identified by specific amplification of the allele at the mating-type locus or mat locus by PCR.

In particular, the following primer pairs can be used to distinguish between the two sexual signs (Mat Alpha and Mat HMG, otherwise known as mat-α (−) and mat-HMG (+)), the full-length sequences of which are referenced in Genbank under accession numbers MG818328.1 and MG818329.1 respectively.

Specific primers Mat Alpha
mat-alpha-F Forward primer
(SEQ ID NO: 13)
5′CACCTCTTTCCAGCAGAAGG 3′
mat-alpha-R Reverse primer
(SEQ ID NO: 14)
5′ CGATTCGCAGGAACTTGTCA3′
Specific primers Mat HMG
Mat-HMG-F Forward primer
(SEQ ID NO: 15)
5′CCCCTCTGACTCTGAACAGC 3′
Mat-HMG-R Reverse primer
(SEQ ID NO: 16)
5′ TGTCGAAATCGTCAATCTGC3′

In a particular embodiment, the conditions for amplification of the mating-type locus are as follows: 2 minutes of denaturation of the V. inaequalis DNA at 95° C. followed by 35 cycles comprising 45 seconds at 95° C., 45 seconds at 60° C., 45 seconds at 72° C. followed by a final extension phase at 72° C. for 5 minutes.

The biocontrol method according to the invention can thus comprise, upstream, and to ensure its targeted effectiveness on endemic POMI pathogenic strains of apple tree, the following steps:
a) Detection of the presence of POMI strains on the vegetative apparatus of apple tree, in particular by PCR, comprising the use of nucleic acid sequences comprising a sequence identical or having at least 90% or even at least 95% identity with one of the nucleic acid sequences SEQ ID NO: 1 to SEQ ID NO: 3 or fragments thereof, in particular the use of primer nucleic acid sequences comprising a sequence identical or having at least 90% or even at least 95% identity with the sequence SEQ ID NO: 9 or SEQ ID NO: 17 (forward primer), a sequence identical or having at least 90% or even at least 95% identity with the sequence SEQ ID NO: 10 or SEQ ID NO: 18 (reverse primer), and mixture thereof;
b) Selection of PYR strains, in particular by PCR or qPCR, comprising the use of nucleic acid sequences comprising a sequence which is identical or has at least 90% or even at least 95% identity with one of the nucleic acid sequences SEQ ID NO: 4 to SEQ ID NO: 8 or fragments thereof, in particular the use of primer nucleic acid sequences comprising a sequence which is identical or has at least 90% or even at least 95% identity with the sequence SEQ ID NO: 11 or SEQ ID NO: 19 (forward primer), a sequence which is identical or has at least 90% or even at least 95% identity with the sequence SEQ ID NO: 12 or SEQ ID NO: 20 (reverse primer), and mixtures thereof;
c) Selection, from among the PYR strains selected in step b), of PYR strains of opposite sexual signs, in particular by PCR or qPCR, comprising the use of pairs of primers respectively a pair of primers mat-alpha-F and mat-alpha-R consisting of the sequences comprising a nucleic sequence identical or having at least 90%, or even at least 95%, identity with the sequence SEQ ID NO: 13 (forward primer, mat-α-F) and a nucleic sequence identical or having at least 90%, or even at least 95%, identity with the sequence SEQ ID NO: 14 (reverse primer, mat-α-R) and a mat-HMG-F and mat-HMG-R pair consisting of the sequences comprising a nucleic sequence identical or having at least 90%, or even at least 95%, identity with the sequence SEQ ID NO: 15 (forward primer, mat-HMG-F) and a nucleic sequence identical or having at least 90%, or even at least 95%, identity with the sequence SEQ ID NO: 16 (reverse primer, mat-HMG-R), and
d) Crossbreeding the PYR strains selected in step c) with the POMI strains identified in step a), to verify that a non-pathogenic or even sterile offspring is obtained.

The PYR strains resulting from selection steps b), c) and d) can then be used, preferably in a mixture consisting of at least two PYR strains of opposite sexual signs, in a biocontrol method or a biocontrol composition according to the invention.

The present invention also relates to a kit for the in vitro detection (or identification) of PYR strains of opposite sexual signs and POMI strains, comprising primer nucleic acid sequences for PCR or qPCR amplification of nucleic acid sequences specific to PYR and POMI respectively, comprising:
a) A pair of primer nucleic sequences comprising a sequence identical or having at least 90%, or even at least 95%, identity with the sequence SEQ ID NO: 9 or SEQ ID NO: 17 (forward primer sp Pomi-F), and a sequence identical or having at least 90%, or even at least 95%, identity with the sequence SEQ ID NO: 10 or SEQ ID NO: 17 (reverse primer sp Pomi-R), to amplify by PCR or qPCR a POMI-specific nucleic sequence, and optionally specific probes, preferably labelled with fluorophores, to detect said amplified sequences,
b) Optionally, in addition, a pair of primer nucleic sequences comprising a sequence which is identical or has at least 90% or even at least 95% identity with the sequence SEQ ID NO: 11 or SEQ ID NO: 19 (forward primer sp Pyr-F), a sequence which is identical or has at least 90% or even at least 95% identity with the sequence SEQ ID NO: 12 or SEQ ID NO: 20 (reverse primer sp Pyr-R), in order to amplify a PYR-specific nucleic sequence by PCR or qPCR, and optionally specific probes, preferably labelled with the PYR-specific nucleic sequences: 12 or SEQ ID NO: 20 (reverse primer sp Pyr-R), for amplifying by PCR or qPCR a PYR-specific nucleic acid sequence, and optionally specific probes, preferably labelled with fluorophores, for detecting said amplified sequences, and
c) Optionally, in addition, two pairs of primers respectively mat-alpa consisting of the sequences comprising a nucleic sequence which is identical or has at least 90% or even at least 95% identity with the sequence SEQ ID NO: 13 (forward primer mat-alpha-F) and a nucleic sequence which is identical or has at least 90% or even at least 95% identity with the sequence SEQ ID NO: 14 (reverse primer mat-alpha-R) and mat-HMG consisting of the sequences comprising a nucleic sequence which is identical or has at least 90% or even at least 95% identity with the sequence SEQ ID NO: 15 (reverse primer mat-HMG): 14 (reverse primer mat-alpha-R) and mat-HMG constituted by the sequences comprising a nucleic sequence identical or having at least 90%, or even at least 95% identity with the sequence SEQ ID NO: 15 (forward primer mat-HMG-F) and a nucleic sequence identical or having at least 90%, or even at least 95% identity with the sequence SEQ ID NO: 16 (reverse primer mat-HMG-F), to amplify sequences specific to the mating-type locus and to select the PYR strains of opposite sexual signs.

The different primer pairs may be present in the same in vitro detection kit or in separate kits.

The present invention will be illustrated by the following non-limiting examples.

### EXAMPLES

### Example 1: Crossbreeding and Obtaining Non-Pathogenic Offspring

A first crossbreed was made between the PYR 1669 strain and the POMI EUB04 strain, and then other crossbreeds were made as described below. This first fertile crossbreed generated ascospores which were cultured and stored at −20° C.

Crossbreeding PYR and POMI strains is carried out by depositing mycelium or a concentration of spores (150,000 spores/ml) of each strain, previously mixed on an inert support, such as a portion of sterilized apple leaves placed in a Petri dish containing an agar medium. After deposition of the fungal material, the inert supports (round or square leaves) are incubated for 21 days at 17° C. in the dark and then placed at 8° C. for 140 days. The resulting pseudothecia are then crushed, releasing the ascospores which are then dispersed in water on a Petri dish containing a mixture of Malt agar. After 48 hours of incubation at 18° C., the germinated ascospores are isolated individually under a light microscope and then cultured at 18° C. in a Petri dish on agar medium.

In this first study, the pathogenicity of 38 offspring obtained by crossbreeding PYR 1669 with POMI EUB04 was evaluated on the apple cultivar ‘Gala’ on the one hand and on the pyracantha cultivar ‘Kazan’, known to be susceptible to scab, on the other hand according to the protocol described by Le Cam et al. 2002. Plants were inoculated with a spore suspension of each offspring at a concentration of 150,000 spores/ml and then placed at 17° C. in a climate chamber. Plants (apple and pyracantha) were then scored for the presence of disease at different times (15, 20-23, and 27 days after inoculation). At 27 days after inoculation, none of the 38 offspring of the crossbreed was pathogenic on the apple variety ‘Gala’, 35 were pathogenic on the pyracantha variety ‘Kazan’ with varying levels of aggressiveness (FIG. 1) and finally 3 offspring were non-pathogenic on both apple tree ‘Gala’ and Pyracantha ‘Kazan’.

Additional crossbreeds were made between PYR 1669 strain and a mixture of 5 POMI strains (301+2498+2499+2788+EU-NL-19), PYR 1386 strain and POMI 2556 strain, PYR 1387 strain with POMI 2557 strain and with a mixture of 5 POMI strains (104, 2416, 2429, 2444, 2557), PYR 2299 strain with POMI 2557 strain and with a mixture of 5 Pomi strains (104, 2416, 2429, 2444, 2557), PYR 2507 strain with a mixture of 5 POMI strains (104, 2416, 2429, 2444, 2557) and PYR 1381 strain with POMI 2556 strain.

These fertile crossbreeds resulted in ascospores that were grown and stored at −20° C.

The crossbreeding between the PYR and POMI strains are carried out as described above by depositing mycelium from each of the strains previously mixed or 40 μl of a suspension mixture of spores from 2 or more strains at a concentration of 200,000 spores/ml, on an inert support, such as a portion of sterilized apple leaves placed in a Petri dish containing an agar medium. After deposition of the fungal material, the inert supports (round or square leaves) are incubated for 14 days at 17° C. in the dark and then placed at 8° C. for 10 days. The resulting pseudothecia are then crushed releasing the ascospores which are then dispersed in water on a Petri dish containing a mixture of Malt agar. After 48 hours of incubation at 18° C., the germinated ascospores were isolated individually under a light microscope and then cultured at 18° C. in Petri dishes on an agar medium.

At the end, out of all the crossbreeds made, the pathogenicity of 84 offspring obtained by crossbreeding with the parental strains PYR 1669, PYR 2299, PYR 2507 and PYR 1387 was evaluated on apple plants on the one hand and on Pyracantha on the other. All 84 offspring were tested on the pyracantha variety ‘Kazan’ known for its susceptibility to scab following the protocol described by Le Cam et al. 2002. 21 offspring of the PYR 1669 crossbreed with POMI EUB04 were tested for pathogenicity on seedlings of the variety ‘Gala’, the other 31 offspring of this crossbreed and the offspring of the other crossbreed were tested on the apple cultivars ‘Gala’ and ‘Golden Delicious’, which are known to be susceptible to apple scab according to the protocol described by Le Cam et al. 2002. Plants were inoculated with a spore suspension of each offspring at a concentration of 150,000 spores/ml and placed at 17° C. in a climate chamber. Each offspring was tested on 3 plants. The plants (apple tree and pyracantha) were then scored for the presence of disease at different times (15, 20 days after inoculation). 20 days after inoculation, none of the 84 offspring of the 4 crossbreeds were found to be pathogenic on the apple varieties ‘Gala’ and ‘Golden delicious’. 24 offspring of the PYR 1669×POMI EUB04 crossbreed were found to be pathogenic on the Pyracantha variety ‘Kazan’ and 59 offspring were found to be non-pathogenic on both apple tree and Pyracantha.

These various crossbreeds and the results obtained are summarized in the following table: Summary table of the PYRxPOMI crossbreed made for which offspring were obtained and for some of them, tested on apple tree and pyracantha

| | | Number of | | |
|---|---|---|---|---|
| Crossbreeding | | phenotyped | | |
| between PYR | Number | offspring on | Pathogenic | Pathogenic |
| strain × POMI | of | apple tree | offspring | offspring |
| strain alone or | offspring | and | on apple | on |
| in mixture | obtained | pyracantha | tree | Pyracantha |
| 1669 × (301 + 2498 + | 6 | not tested | | |
| 2499 + 2788 + | | | | |
| EU-NL-19) | | | | |
| 1669 × EUB04 | 52 | 52 | 0/52 | 24/52 |
| 2299 × (104 + 2416 + | 55 | 15 | 0/15 | 0/15 |
| 2429 + 2444 + 2557) | | | | |
| 2299 × 2557 | 9 | not tested | | |
| 2507 × (104 + 2416 + | 28 | 5 | 0/5 | 0/5 |
| 2429 + 2444 + 2557) | | | | |
| 1387 × (104 + 2416 + | 83 | 12 | 0/12 | 0/12 |
| 2429 + 2444 + 2557) | | | | |
| 1387 × 2557 | 15 | not tested | | |
| 1381 × 2556 | 57 | not tested | | |
| 1386 × 2556 | 67 | not tested | | |

### Example 2: Offspring Infertility Tested in Backcross (Offspring×POMI Strains)

Backcrossing between hybrids (PYRxPOMI offspring) and POMI strains (alone or in mixtures, see table below) are carried out. The presence of pseudothecia and the presence or absence of ascospores inside are observed.

Analysis of the contents of the pseudothecia consists of crushing the pseudothecia between slides and coverslips and observing the presence of ascospores under the microscope.

The results are presented in the following table, where the FIGURE indicates the number of pseudotheces observed and analyzed in backcrosses (PYRxPOMI×POMI):

| Hybrid strains | Mixture 1 | Mixture 2 | |
|---|---|---|---|
| (PYR × POMI | of POMI* | of POMI** | |
| Offspring) | strains | strains | POMI Strain 2557 |
| 10C53 | 31 | | 1 |
| 10C179 | 44 | | |
| 10C204 | | 23 | 0 |

*Mixture 1 of POMI strains consists of strains 104, 2416, 2429, 2444, 2557
**Mixture 2 of POMI strains consists of strains 481, 2286, 2288, 2432, 2556

None of the pseudothecia analyzed contained ascospores, i.e. no offspring. These results suggest infertility/sterility of PYRxPOMI offspring. The biocontrol method according to the invention would therefore lead to the production of non-pathogenic and sterile offspring, which would not survive the winter, even though they would have managed, for possible low pathogenic offspring, to infect the apple tree and thus survive in the orchard during the summer.

### Example 3: Selection of PYR Strains by PCR

For the selection of PYR strains to be used in a method according to the invention, the following primers can be used:

Specific primers POMI (Vina_EUB04.g9008_spPomi,
expected size of the amplicon = 163 pb)
(SEQ ID NO: 9)
spPomi-F, Forward primer GTTATGTCTGGCCGCGTTAT
(SEQ ID NO: 10)
spPomi-R, Reverse primer AGAAAAGCTGGCACCTCGTA
Specific primers PYR (Vina_1669.g9936_spPyr,
expected size of the amplicon = 157 pb)
(SEQ ID NO: 11)
spPyr-R Forward primer CAAGCGAGCTGAAATCGAG
(SEQ ID NO: 12)
spPyr-F Reverse primer GTACAACCCGATCCCTTTTG

The selection of PYR strains or POMI strains within V. inaequalis strains includes the following steps:
a) extraction of DNA from V. inaequalis strains
b) denaturing said extracted DNA
c) using forward (direct) and reverse (indirect) primers as described above for PCR or qPCR amplification of POMI-specific nucleic acid sequences such as SEQ ID NO:1 to SEQ ID NO:3 or fragments thereof, or for PCR or qPCR amplification of PYR-specific nucleic acid sequences such as SEQ ID NO:4 to SEQ ID NO:8 or fragments thereof, and
d) and optionally using specific probes, advantageously labelled with fluorophores to detect said amplified nucleic sequences or fragments thereof, allowing categorization of POMI strains and PYR strains.

The conditions for locus-specific amplification of the POMI and PYR forms are as follows: 2 min of denaturation of the V. inaequalis DNA at 95° C. followed by 35 cycles including 30 seconds at 95° C., 30 seconds at 60° C., 30 seconds at 72° C. followed by a final extension phase at 72° C. for 5 min.

The PYR strains selected in this way can be used in crossbreeding and obtaining a pathogenic offspring according to example 1 described above.

### Example 4: Selection of PYR Strains by Taqman Multiplex qPCR

In this example, two special forms Venturia inaequalis fsp. pomi and Venturia ineaqualis fsp. Pyracantha were detected and quantified. The following steps were performed:
1) Design of specific primers and probes on 2 specific loci of each special form
2) DNA extraction with the Nucleospin Food kit (Macherey Nagel)
3) Taqman multiplex qPCR

Amplification Protocol:

1: 95.0° C. for 3:00 minutes

2: 95.0° C. for 0:15 minute

3: 60.0° C. for 1:00 minute

Reading the Plate

4: repeat the cycles 39 times

Primers and Probes with Fluorochromes Used (FAM and CY)

| | | |
|---|---|---|
| (SEQ ID | spPomi-F | AAAGGTCCCCTCACGAATAC |
| NO: 17) | Forward | |
| | primer | |
| (SEQ ID | spPomi-R | GATCTGTTTCCCTTCCACCT |
| NO: 18) | Reverse | |
| | primer | |
| (SEQ ID | POM/- | [FAM]TGCCATCTGGATCGGAACAA[BHQ3] |
| NO: 21) | specific | |
| | labelled | |
| | probe | |
| (SEQ ID | spPyr-F | GAGTTATTGCTGAGGCCAAG |
| NO: 19) | Forward | |
| | primer | |
| (SEQ ID | spPyr-R | GCCTTGACTGTGCTCGTAAC |
| NO: 20) | Reverse | |
| | primer | |
| (SEQ ID | PYR- | [CY5]GCTCCAACCGTTGGTGGAGA[BBQ3] |
| NO: 22) | specific | |
| | labelled | |
| | probe | |

Composition of the Reaction Mix:

| | ×1 |
|---|---|
| Mix 2× ssoAdvanced Biorad | 5 μl |
| spPomi-F Forward primer 10 μM | 0.5 μl |
| spPomi-R Reverse primer 10 μM | 0.5 μl |
| Sonde_pomi 10 μM | 0.2 μl |
| spPyr-F Forward primer 10 μM | 0.8 μl |
| spPyr-R Reverse primer 10 μM | 0.8 pl |
| Probe_pyr 10 μM | 0.4 μl |

It is observed that POMI-specific primers (FAM) amplify only POMI strains and PYR-specific primers (CY5) amplify only PYR strains.

### Example 5: Demonstration of the Phytoprotective Effect of an Application of PYR Strain Against Apple Scab

This study was carried out on the Golden Delicious variety on the one hand and the Gala variety on the other

2 tests were carried out respectively with:

PYR (1387+POMI 2257) vs Water+POMI (2257), on 12 plants of the variety Golden Delicious

PYR (1381+POMI 2256) vs Water+POMI (2256), on 8 plants of the variety Gala.

The inoculum of PYR 1387 strain (respectively 1381) was prepared at a concentration of 250,000 spores/ml and that of POMI 2557 strain (respectively 2256) at a concentration of 80,000 spores/ml. The experiments were carried out in climatic chambers on the Golden Delicious and Gala varieties respectively. 24 hours before inoculation with POMI 2557, a total of 20 trees were sprayed with a spore solution of PYR 1387 (12 trees) and PYR 1381 (8 trees) respectively, and a further 20 trees were sprayed with water (control). 24 hours before the application of PYR strain and water, the plants were placed in an atmosphere of 80-90% relative humidity at a temperature of 17° C. The optimal temperature and relative humidity conditions for inoculation and incubation were as described in Le Van et al. Disease severity ratings consisting of measuring the scabbed area per leaf were carried out 10 days after inoculation with POMI 2557 strain (respectively POMI 2556). The compiled results are presented in the following tables which show a significant difference in scab observed on apple leaves pre-treated with PYR 1387 and PYR 1381 respectively, 24 hours prior to inoculation with POMI 2557 and POMI 2556 respectively, compared to apple leaves pre-treated with water (control).

In particular, for each of the two tests, the following results were obtained (average scabbed surface over 12 plants):

Test 1

| | 10dpi | |
|---|---|---|
| | PYR (1387 + POMI 2557) | Water + POMI (2257) |
| Average | 43% (*) | 75% |

*: statistically different
Student's test: p-value = 9.045 · 10-5 (threshold α = 0.05)

Test 2

| | PYR (1381) + POMI (2556) | Water + POMI (2556) |
|---|---|---|
| Average | 20.9% (*) | 37.50% |

Result: average scabbed surface on 8 plants
*: statistically different
Anova test: p-value = 0.0064 (threshold α = 0.05)

These results show that a pre-treatment with a PYR strain can protect the apple tree against a later infection by a POMI pathogen strain, suggesting a phytoprotective effect of the PYR strains, which can be used in a sequential treatment of application of PYR strains in the spring (or even in the summer) and POMI strains in the autumn, in order to couple a ‘phytoprotective’ effect to the ‘biocontrol’ effect described in Example 1.

### Example 6: Biocontrol Composition and Phytoprotection Composition

As an example, a biocontrol composition according to the invention contains 2 PYR 1669 and PYR 2507 of opposite sexual signs mat-HMG and mat-α+, with a final concentration of between 500 spores/ml and 600,000 spores per ml of composition.

According to another example, a biocontrol composition according to the invention contains 2 strains PYR 1381 and PYR 1387 of opposite sexual signs mat-HMG and mat-α+, with a final concentration between 500 spores/ml and 600,000 spores per ml of composition.

According to another example, a biocontrol composition according to the invention contains 2 strains PYR 1381 and PYR 2299 of opposite sexual signs mat-HMG and mat-α+, with a final concentration between 500 spores/ml and 600,000 spores per ml of composition.

According to another example, a biocontrol composition according to the invention contains 2 strains PYR 1386 and PYR 1387 of opposite sexual signs mat-HMG and mat-α+, with a final concentration between 500 spores/ml and 600,000 spores per ml of composition.

According to another example, a biocontrol composition according to the invention contains 2 strains PYR 1386 and PYR 2299 of opposite sexual signs mat-HMG and mat-α+, with a final concentration of between 500 spores/ml and 600,000 spores per ml of composition. As an example, a phytoprotection composition according to the invention contains one or more PYR strains as described above or PYRxPOMI offspring. In case of 2 to 2 mixtures of PYR strains of opposite sexual signs, the same mixtures as described for biocontrol compositions can be used.

Advantageously, these compositions also include wetting, emulsifying, water-retaining and adhesive adjuvants to facilitate the homogenization of the solution, the adhesion of the PYR particles to the plant cover and even their germination.

### REFERENCES

Didelot F, Caffier V, Orain G, Lemarquand A, and Parisi L. 2016. Sustainable management of scab control through the integration of apple resistant cultivars in a low-fungicide input system. Agriculture ecosystems & environment 217, 41-48
Gladieux P, Caffier V, Devaux M, Le Cam B. 2010. Host-specific differentiation among populations of Venturia inaequalis causing scab on apple, pyracantha and loquat. Fungal Genetics and Biology. doi:10.1016/j.fgb.2009.12.007.
Le Cam et al. 2002 “Evidence of two formae speciales in Venturia inaequalis, responsible for apple and Pyracantha scab”, Phytopathology 92:314-320
Le Cam B, Sargent D, Gouzy J, Amselem J, Bellanger M N, Bouchez O, Brown S, Caffier V, De Gracia M, Debuchy R, Duvaux L, Payen T, Sannier M, Shiller J, Collemare J, Lemaire C., 2019. Population Genome Sequencing of the Scab Fungal, Species Venturia inaequalis, Venturia pirina, Venturia aucupariae and Venturia asperata G3, 9: 2405-2414
Lê Van A., Gladieux P., Lemaire C., Cornille A., Giraud T., Durel C. E., Caffier V., Le Cam B. (2012). Evolution of pathogenicity traits in the apple scab fungal pathogen in response to the domestication of its host. Evolutionary Applications 5, 694-704 doi:10.1111/j.1752-4571.2012.00246.

1-12. (canceled)

13. A biocontrol method for combating the spread of phytopathogenic fungi or oomycetes on plants, comprising the application, to the soil and/or to the vegetative apparatus of plants infected or liable to be infected by strains of endemic pathogenic fungi or oomycetes known as type A, of a composition comprising a mixture of at least two strains, called type B, of the same species or of a divergent population within said species, said type B strains being non-pathogenic for said plant, sexually compatible with said pathogenic type A strains and characterized in that they have:
a) a sexual reproduction,
b) a sexual phase initiated in a non-parasitic mode,
c) a reproduction according to a heterothallic mode, and
d) the existence of special forms or divergent populations within the species, capable of producing, by crossbreeding with type A strains, non-pathogenic or even sterile offspring on said plant of interest,
and characterized in that the mixture of non-pathogenic type B strains comprises strains of opposite sexual signs.

14. The method according to claim 13, wherein the type B strains are applied to the vegetative apparatus in the vegetative growth phase of plants infected or liable to be infected by strains of pathogenic endemic fungi or oomycetes known as type A, then to the vegetative apparatus in the senescence phase of said plants.

15. The method according to claim 14, wherein the type B strains are applied to the senescent leaves or to the dead leaves which have fallen on the soil, of said plants infected or liable to be infected by strains of endemic pathogenic fungi or oomycetes known as type A.

16. The biocontrol method according to claim 13, wherein:
a) said phytopathogenic fungus is selected from the group consisting of: Venturia inaequalis responsible for apple scab, Zymoseptoria tritici responsible for septoria in wheat, Blumeria graminis responsible for powdery mildew in wheat, Mycosphaerella fijiensis responsible for cercosporiose in banana, and Leptosphaeria maculans responsible for crown necrosis in oilseed rape; or
b) said oomycete is selected from the group consisting of: Plasmopara viticola responsible for downy mildew of grapevine, and Phytophthora infestans responsible for downy mildew of potato and tomato.

17. The biocontrol method according to claim 16, wherein the said phytopathogenic fungus is Venturia inaequalis responsible for apple scab.

18. The biocontrol method according to claim 17, wherein the composition applied to the vegetative apparatus of the apple tree comprises a mixture of at least two Venturia inaequalis type B strains of the special pyracantha-specific form (f. sp pyracantha or PYR) and of opposite sexual signs.

19. The biocontrol method according to claim 18, wherein the two Venturia inaequalis type B strains of the special pyracantha-specific form (f. sp pyracantha or PYR) and of opposite sexual signs, are selected according to an in vitro method comprising:
an extraction step for the DNA of Venturia inaequalis strains;
a PCR or qPCR amplification step of specific nucleic sequences of the genome of the PYR strains, by means of specific nucleic primers; and
an amplification step by PCR or qPCR of sequences specific to the mating-type locus, comprising the use of a pair of mat-alpha primers consisting of the sequences comprising a nucleic sequence identical or having at least 90% identity with the sequence SEQ ID NO: 13 (forward primer mat-alpha-F) and a nucleic sequence identical or having at least 90% identity with the sequence SEQ ID NO: 14 (reverse primer mat-alpha-R) and a pair of mat-HMG primers consisting of the sequences comprising a nucleic sequence identical or having at least 90% identity with the sequence SEQ ID NO: 15 (forward primer mat-HMG-F) and a nucleic sequence identical or having at least 90% identity with the sequence SEQ ID NO: 16 (reverse primer mat-HMG-R).

20. The biocontrol method according to claim 19, wherein the two Venturia inaequalis type B strains of the special pyracantha-specific form (f. sp pyracantha or PYR) and of opposite sexual signs, are selected according to an in vitro method comprising:
an extraction step for the DNA of Venturia inaequalis strains;
a PCR or qPCR amplification step of nucleic sequences comprising a nucleic sequence identical or having at least 90% identity with one of the sequences SEQ ID NO: 4 to SEQ ID NO: 8, by means of a forward primer with a nucleic sequence which is identical or has at least 90% identity with the sequence SEQ ID NO:11 or SEQ ID NO:19 (forward primer sp Pyr-F) and a reverse primer with a nucleic sequence which is identical or has at least 90% identity with the sequence SEQ ID NO:12 or SEQ ID NO:20 (reverse primer sp Pyr-R);
an amplification step by PCR or qPCR of sequences specific to the mating-type locus, comprising the use of a pair of mat-alpha primers consisting of the sequences comprising a nucleic sequence identical or having at least 90% identity with the sequence SEQ ID NO: 13 (forward primer mat-alpha-F) and a nucleic sequence identical or having at least 90% identity with the sequence SEQ ID NO: 14 (reverse primer mat-alpha-R) and a pair of mat-HMG primers consisting of the sequences comprising a nucleic sequence identical or having at least 90% identity with the sequence SEQ ID NO: 15 (forward primer mat-HMG-F) and a nucleic sequence identical or having at least 90% identity with the sequence SEQ ID NO: 16 (reverse primer mat-HMG-R).

21. The biocontrol method according to claim 19, wherein the in vitro method for selecting the two Venturia inaequalis type B strains of the special pyracantha-specific form (f sp pyracantha or PYR) and of opposite sexual signs, further comprises a detection step of said amplified sequences by means of probes.

22. The biocontrol method according to claim 13, wherein the composition is applied by spreading on the vegetative apparatus of said plants and/or on the soil in orchards.

23. The biocontrol method according to claim 13, wherein it comprises the application to the soil and/or to the vegetative apparatus of plants infected or liable to be infected by strains of endemic pathogenic fungi or oomycetes known as type A, of a biocontrol composition comprising a mixture of at least two sexually opposite type B strains of a phytopathogenic fungus or oomycete not pathogenic to the plant to be treated and which are sexually compatible in crossbreeding with type A strains of the same species, wherein said phytopathogenic fungus is selected from the group consisting of: Venturia inaequalis responsible for apple scab, Zymoseptoria tritici responsible for septoria in wheat, Blumeria graminis responsible for powdery mildew in wheat, Mycosphaerella fijiensis responsible for cercosporiose in banana, and Leptosphaeria maculans responsible for crown necrosis in oilseed rape; and said oomycete is selected from the group consisting of: Plasmopara viticola responsible for downy mildew of grapevine, and Phytophthora infestans responsible for downy mildew of potato and tomato.

24. A biocontrol composition comprising a mixture of at least two Venturia inaequalis type B strains of the special pyracantha form (f. sp pyracantha or PYR).

25. The biocontrol composition according to claim 24, wherein it comprises a mixture of the V. pyra 1669 strain deposited at the CNCM under the No. CNCM I-5456 and the V. pyra 2507 strain deposited at the CNCM under the No. CNCM I-5457, or a mixture of the V. pyra 1381 strain deposited at the CNCM under the No. CNCM I-5627 and the V. pyra 1387 strain deposited at the CNCM under the No. CNCM I-5629, or a mixture of the V. pyra 1381 strain and the V. pyra 2299 strain deposited at the CNCM under the No. CNCM I-5630, or a mixture of the V. pyra 1386 strain deposited at the CNCM under the No. CNCM I-5628 and the V. pyra 1387 strain deposited at the CNCM under the No. CNCM I-5629, or a mixture of the V. pyra 1386 strain and the V. pyra 2299 strain deposited at the CNCM under the No. CNCM I-5630.

26. The biocontrol composition according to claim 24, wherein the strain mixture is present in a concentration ranging from 500 spores/ml to 600,000 spores/ml, in particular 5,000 to 400,000 spores/ml of composition.

27. A phytoprotection method for combating plant infection by phytopathogenic fungi or oomycetes, comprising the application to the vegetative growing apparatus of plants infected or liable to be infected by so-called type A strains of pathogenic endemic fungi or oomycetes, one or more type B strains, or type A by B offspring, said type A and type B strains being as defined in claim 13.

28. The method according to claim 27, wherein it comprises: the application of one or more Venturia inaequalis type B strains of the special pyracantha form (f. sp pyracantha or PYR), or PYRxPOMI offspring.

29. The method according to claim 28, wherein the Venturia inaequalis type B strains of the special pyracantha form (f. sp pyracantha or PYR) are selected from the group consisting of the V. pyra 1669 strain deposited at the CNCM under the No. CNCM I-5456, the V. pyra 2507 strain deposited at the CNCM under the No. I-5457, the V. pyra 1381 strain deposited at the CNCM under the No. CNCM I-5627, the V. pyra 1387 strain deposited at the CNCM under the No. CNCM I-5629, the V. pyra 2299 strain deposited at the CNCM under the No. CNCM I-5630, the V. pyra 1386 strain deposited at the CNCM under the No. CNCM I-5628, and their mixtures.
